(19) United States
(12) Patent Application Publication
(10) Pub. No.: US 2010/0318440 A1
(43) Pub. Date: Dec. 16, 2010

(54) Cashierless, Hygienic, Automated, Computerized, Programmed Shopping Store, Storeroom And Supply Pipeline With Administration Cataloguing To Eliminate Retail Fraud; With Innovative Components For Use Therein

(76) Inventor: Michael EJ Coveley, Richmond Hill (CA)

Correspondence Address: Michael Coveley, 6 Fairview Avenue, Richmond Hill, ON, L4C 6L2, omitted

(21) Appl. No.: 12/727,064

(22) Filed: Mar. 18, 2010

(51) Int. Cl. G06Q 30/00; G05B 19/00; G01G 19/40; G08B 21/00

(52) U.S. Cl. 705/26.1; 340/5.9; 235/383; 177/25.15; 340/540

(57) ABSTRACT

A Cashierless unattended point of sale, shopping store procurement payment means, with storeroom reordering system using a layered wireless linked monitoring and cataloguing system; includes an interfacing electronic configured self-owned reusable three-wheel fold-up shopping trolley with suspended color-coded bins; into which merchandise maybe placed and registered by a passive reading sensor array. A ‘load-cell’ integral to the trolley precisely quantifies and approves trolley bin contents for exit payment through a TCP/IP means. An evaluation wireless communication link repeatedly reviews “polled' trolley content data, this integrated communication link, is networked to the store Operations Center, wherein purchased inventory data is recorded and verified; upon shopping completion the contents are again finally substantiated for final electronic settlement. This self-contained cashierless enclosed shopping method provides retail loss prevention, real-time progressive inventory management and reorder, eliminates space to sales; being convenient for shoppers and store owners; making all egress points electronically restricted.

### REFERENCES CITED

U.S. Pat. No. 6,725,206 B1, Apr. 20, 2004, Coveley M. ‘Cashierless Shopping Store And Components For Use Therein’. ABSTRACT: A Cashierless shopping store including a plurality of shopping carts into which selected items to be purchased are placed by shoppers. Each of the shopping carts includes a weight detector to measure the weight of items placed therein and a transmitter to transmit the measured weights over a wireless communication link. A portable wireless shopping terminal accompanies each of the shopping carts. Each shopping terminal reads item price and item weight data from each selected to be purchased and receives the measured weight of each selected item transmitted over the wireless communication link by the transmitter. The shopping terminal compares the read item weight data and the transmitted measured weight for each selected item correlate. At least one checkout station is provided and includes a scale to measure the total weight of selected items in a shopping cart and a transmitter to transmit the measured total weight over the wireless communication link to the shopping terminal accompanying that shopping' cart. The shopping terminal compares the measured total weight with the sum of the read item weight data to determine if the weights correlate

U.S. Pat. No. 7,559,482 B2, Jul. 14, 2009, Coveley M. ‘Supplementary Antenna for RFID And Product Containing Unit Incorporating Same’. ABSTRACT: A housing having at least one main Balun antenna within the housing product holder, the product holder contains RFID Tagged produce. At least one supplementary antenna is positioned adjacent to the product holder to cause RFID tags on the produce to oscillate when excited by the main Balun antenna.

U.S. Pat. No. 6,563,813 B1, May. 13, 2003, Coveley M. ‘Wireless Transport Protocol’. ABSTRACT: A wireless transport protocol for data packets transmitted over a wireless communication network includes a user data field having data to be transmitted by a sending party to a receiving party. At least one sequencing field is appended to the data field. At least one sequencing field includes information identifying the last data packet received by the sending party that was transmitted by the receiving party. This allows a sending party to determine whether the receiving party has received data packets by examining data packets received from the receiving party.

U.S. Pat. No. 6,873,620 B1, Mar. 29, 2005, Coveley M. ‘Communications Server Including Virtual Gateway To Perform Protocol Conversion And Communication System Incorporating The Same’. ABSTRACT: A communication system comprises at least two communications over which communication between physical devices connected to the communication networks are carried out. The communication networks implement different protocols for messaging. A communication server acts between the communication networks. Messages between the communication networks pass through the communication server. The communication server includes a knowledge base storing protocol conversion information. The communication server accesses the protocol conversion information in the knowledge base upon receipt of a message and converts the protocol thereof to a protocol compatible with the communication network to which the message is being sent.

### TECHNICAL FIELD OF THE INVENTION

The present invention relates to providing an end-to-end solution for merchandize being electronically monitored and catalogued within a supermarket cashierless shopping store and storeroom environment. Using an electronic sensor array and weight detector integrated into each client owned, folding, self-contained trolley; where the item is product assessed, weighed and value compared within the trolley. This evaluated check sum is stored in the trolley CPU and submitted when ‘poled’ from the trolley by the store antenna ‘poling’ network as the trolley passes by active Balun pairs and onward transmitted by WLAN to the shopping store Operations Center for categorizing, compiling and recording. The present invention also provides diligent inventory management in replenishment of identified merchandise for shelf and counter restock of space to sales. The merchandise cyclic transition is correspondingly electronically monitored as it passes from the storeroom to store correlating a means for retail loss prevention with real-time monitoring of all inventory interchange, which is constantly electronically ‘poled’, scrutinized and catalogued. This also enables administration these events procedures and provisions for supply pipeline merchandise precise reorder. This present invention provides for beneficial shopping transactions, being meticulous tallied, journal monitored shopping means with extensive complimentary promotional awareness capture for the client shopper within a cashierless hopping store with components for use therein.

### BACKGROUND OF THE ART

Retail Grocery shopping is a task performed by virtually every household at least on a weekly basis. It is unnecessarily time consuming, bothersome and annoying, essentially because of the lack of product information and location assistance; with customarily long checkout lines that are cashier manually serviced, wasting time better spent shopping. Today's retail shopping particularly in groceries ‘modus-operandi’, culminates numerous unsanitary and working inefficiencies, delimits the already minimal workforce productivity; imparts only partial in certain cases even fractional real time data to the client shopper or store management. Cooperative interaction or meaningful communication between the client shopper, store staff and store management is sometimes apprehensive and often times virtual nonexistent. The present status and rating for shopping and payment practices generously provoke deception and cheating throughout the store and stockroom, not just from incoming store merchandize shipments within the store room, but to internal store dispersal and to outgoing product point of sale. The current mode of shopping and cart conveying of grocery merchandise is tediously careworn, often times carts are considerably debilitated, becoming unwieldy, difficult to maneuver, and time and again most grubby; in certain cases unhygienic. The existing carts are used over and over repeatedly on an hourly daily basis; some are left with merchandise breakage residue at times many days old. These carts habitually remaining for period's out-of-doors within parking lot environments; routinely overnight and across weekends and for holiday periods making them also weather dirty. As a consequence their impracticability cage design, particularly the clumsy child seat arrangement makes them impossible to be unsoiled. The undersized wheels and lower shelf are totally inapt, the entire construction problematical to thorough cleaning, rendering them unsanitary and perceptibly unhealthy. Lamentably, into which shoppers are required to place their wrapped and sometimes-loose foodstuff with glass bottle grocery merchandise. This spacious holder within the cart design allows free movement and jarring, which unravels and allows product to become uncovered.

As we enter the 21^{st} Century consumers should not be forced to tolerate today's ‘Supermarket’ slipshod, in fact considerably lackadaisical handling means, making them during conveyance of purchased products the very reason and cause for unwrapped loose merchandise mess within the carts. The other current method of conduct with carts is they frequently befall other denigration abuses both inside and outside the store from tainted misuse. The health considerations must be well thought-out wherein shoppers are expected to situate their food within these carts without knowing previous exploits. The shopper quite unaware is expected to grasp a multi-use contaminated cart handle, which is never sanitized while then further handling purchased foodstuffs.

Within the store with current methods, often times consumers have to meander throughout the aisles, re-tracing, looking for goods that have been arbitrarily moved to entirely new locations, often times having a negative effect on the shopper. As the shopping effort progresses product items are placed randomly and inelegantly in the large open void of the existing carts, freely able to topple over from sudden movement; contents of the cart become quite mixed up and cluttered. Consumer shoppers often times face inadequate help from a rotating part-time staff who are generally uninformed, often unacquainted as to product type; certainly unaware as to other alternative merchandise choices. Present day shoppers proceed through product aisles randomly ‘loading’ the cart, then at manual checkout ‘unload’ at the same time scrambling the contents onto a more often than not soiled rubber belt conveyor, caused by prior spills or leaks. Allowing the handling cashier to further haphazardly re-scramble the merchandise, as it is recorded then loaded into plastic bags; as such it is seldom known what each bag might contain.

Upon completion at these existing style checkout lanes, consistent manual errors occur, wherein erroneous charges and inaccurate weighing and pricing applied. Specials displayed on the shelf are often times ineptly missed at the manual cashier register. Expired specials remain unchecked and mistaken at the register when inadvertently not updating. This method of shopping continues to suffer other downsides and shortcomings, where barcode labels are over-labeled by dishonest shoppers particularly with wrapped and bagged produce; again in store unobserved or ignored weighing errors can also occur. Undesirably, in such case there is no instantaneous on the spot check and this in part enhances inventory shrinkages. At the moment this demonstrates a total lack of accurate communication between consumer shoppers, store staff and store management; today's actions and tricks would fall way short if related back to the old open-air marketplaces of yesteryear. Because of these susceptible occurring events with other unnoticed and disregarded shrinkage activities, retail fraud flourishes to ever-new thresholds taking on a buoyant stature. This necessarily reveals that today's outdated schemes have for a considerable time remained open to exploitation. These abject existing schemes used by all mass-merchants are not designed for and do not allow for adequate security safeguards or checkpoints. Conspiracies and machinates can very easily bypass existing protection, among them, the sharp practice of barcode ‘sticker-switch’ which is problematic to interpretation and discovery, seldom picked-up at the checkout. For instance in 2008 retail fraud had risen in North America and Canada to $36.3 billion USD according to the ‘National Retail Security Survey’, the actual figures are not yet available for 2009 but they are said to be mounting in excess of those numbers.

A further growing concern is the continued and intensification use of plastic disposable bags, which are non-biodegradable and become a growing concern to the ecosystem and thus a major environmental hazard. This deliberate and acutely ignored predicament continues to expand and become the forefront of world news. These bags find their way into the oceans, the harm and impairment these bags cause will eventually be the grounds for their elimination. It would be entirely beneficial if significant improvements and augmentation upgrades to the entire existing outmoded, passé-shopping style could be inaugurated; requiring a major shift towards ecological improvement.

A new system that realigns towards a more user friendly, hygienic, accurate conformity, having improved internal organizational efficiencies, interconnected cataloguing elucidation with client shopper and store management exposed to an intrinsic monitoring and classification procedure. Operations dependable, providing a complete consumer advisory, while protecting the store against shopping inventory shrinkages, storeroom diminution and specifically pipeline of supply shortages.

### SUMMARY OF THE INVENTION

The installation cost effectiveness of the Inventor's prior Patents is now further integration enhanced and provides a beneficial system upgrade of components used and their setting up, and provides significant improved cost expenditures. This system entails very limited antenna wiring installation being essentially a three layered wireless intranet. Eliminates all the manual inadequate and inaccurate paper routing procedures and slow labor-intensive documentation paper practices.

With the onset approach of immensely low cost modern passive tagging and predominantly passive RFID ferrite backed tags and produce label printing techniques using, these passive RFID, ultrasonic, harmonic and magnetostructive-acoustic Tagging will definitely in due course be used on most all merchandise and retail products, including metalized packaging; such as cans and jars with metal lids. Incorporating use of these latest and emerging innovative tags link-networked electronic low-power and compact mechanisms allows provision for very low standalone installation, communication and monitoring costs; while having much greater efficacy and efficiency over existing in-store unrelated management methods. This progressive invention controls and endows total security, while enabling superior shopper's awareness, assistance and support; this up-graded system is both intelligent and in-store scaleable, while also incorporating use of the existing inconsistent barcode system. The endeavored use of this contemporary tagging for Food and other Retail Merchandise was constrained because of lack of a cost-effective ability in reading RFID tags placed on metal or metal-foil packaged produce. However, with affordable RFID dice now ferrite shield layered behind the antenna, which protects and stabilizes against antenna de-tuning making it functional; this also includes the use of ultrasonic, harmonic magnetostructive-acoustic tagging. Inlayed active Balun array loops either vertical or horizontal also take advantage of the expanded memory stacked protocol low cost dice. The capability of these new reader arrangements provides improvement from the well-defined real-time data streams.

It is stated that parts of Europe and South East Asia Japan especially, are placing more individual shopping direction under the control of consumers in performing their own checkout product scanning.

Generally stated the present invention includes interconnection between both front-end shopping areas, and back-end warehousing areas including pipe-lines of supply; whose working measures include the same arranged RFID WLAN integrated link-networking conduct to an outside WWAN. In addition to the upgraded passive/active RFID/Sensory means the Cashierless Checkout, via Operations Center can meticulously examine, cross-reference monitor shopping habits client shoppers evolving shopping trends with ultimate payment scheme chosen.

The uses of modern RFID ultra wide bandwidth [UWB], open RFID Global Standards at [LF: 125-134.2 kHz and 140-148.5 kHz] also for [HF: 13.56 MHz] and for [UHF: 868-928 MHz]; that are utilized in this patent allows provision for a complete, built-in, seamless purchasing cashierless method of consumer unattended point of sale shopping with payment obtained during a casual inherent walk-through at the checkout zone without any produce item having to be removed from the bins.

The attribute peripherals used include the latest fast low-energy power chip sets and readers for passive Balun and active Balun pairs, that scaleable including ultrasonic, harmonic and magnetostructive-acoustic readers. These detector readers are encapsulated insitu within the bin brims operating at 2.5-volts DC, which in turn achieves substantial extended battery life 2.5 to 3-years dependant upon extent and shopping cycles. The ubiquitous positioning of the active RFID Balun loops that are store mounted strategically single or in pairs are locality powered to a main supply 110-Volts AC brick transformer stepped down to operating 2.5-volts DC for the Balun. An omnipresent powerful wireless integrated link network to open ISMB Global Standards in both cases RFID, and WLAN for any three bands 868-928 MHz, 2.45 GHz and 5.8 GHz. With a wireless internal Gateway enabling device DirectGate NOC and external Virtual Gateway WWAN, having Cellular, proprietary WWAN, Ethernet and Internet using distributed Wireless Transport Protocol, link network stacks for all communications.

Also takes into account all the principle activities for ‘pipeline of supply’ reorder and allocation, with store shelf automatic restock based upon real-time monitoring, instant accruals, daily state-of-affairs updates, providing prompt re-supply of store-shelves avoiding ‘space to sales’; utilizing e-Shop/e-Dispense Software that provides pick-up implementation of internal charge-back capabilities. Also provides Operations Center continued aptitude of constant shopping information re-acquire, by time period phased ‘polling’. This achieves overall information verification from the active RFID Balun following repeated walk-through passing ‘poll's’, which provide continually total collaboration of trolley shopping content. This activity also takes account of transfer and interchange between client shoppers trolley CPU and Operations Center be a consequence for storeroom reorder compilation updates. Overall Software management tools, e-Shop and e-Dispense are an effective database system that provides client shoppers with convenient access to product information and their accrued purchases and tally in a secure environment. Client Shoppers ‘Look-up’ necessities are from a ‘touch screen’ with rollover provisions providing a quick glance of by and large shopping activities. The display system upon request will make competitive comparisons while providing statistical content information and alternative contrasts in purchase values. This software would include a toolbox with set of added libraries, updates and maintenance for assist with continuing escalating Store Control needs. The overall system includes reorder resources, with matching interrogator that interprets all shopping merchandize use tendencies, highlights for Operations Center product shelf life span scanning. Incorporates all merchandize inventories scheduling with shelf and storeroom twenty-four hour closeout balancing, all client shoppers data trends, including overlay of shoppers prior history. The system encompasses a total shelf audit with a complete report generation. Following each client shoppers purchasing succession at completion and approach to the checkout zone the ‘payment security’ intelligence watchdog, provides an absolute accrual recount quantification; as protection checks for both client shopper and store management.

This group of three-layered wireless linked networking system promotes between client shopper and store management proper, a complete procurement futuristic insight. Provides Operations Center, storeroom ease of recurring predictor re-order possibility. It also imparts educationally, ‘cultural tutoring’ making available to the client shopper a merger of recipe ideas, a confluence of different ethnic ideas with ease to locate these respective ingredients within the store, previously not well known to the shopper. This WLAN duplex system and two-way WWAN elevates program competence to Head Office interconnectivity. This further allows advertising display ‘bill-board’ benefits, including shoppers score updates and relevant awards, through the trolley electronic touch screen display. A supporting rollover screen function displays the store's map as a ‘birds-eye-view’ portraying store aisle location mapping. The store is also able to emphasize healthcare and welfare with any particular medication subsidy opportunities. The same applies to general merchandising categories; opening-out all possible customer services and focusing attentiveness towards actual store brand product opportunities.

This accommodating methodology remains structured throughout the shopping sequence from start to cashierless checkout zone final point of sale. The operational software described operating the system provides customer centric conveniences, easy produce accesses, while increasing sales and optimizing profits; the store also gains from date era specifics avoiding losses from product expiry timeouts and spoilage. Following shopping conclusion, weight and multiplicity of sensor readouts comparison checks allow payment processing for approval at a leisurely uninterrupted walking pace through the checkout zone via recognized TCP/IP routing and dispensation accommodated by either Credit Card, Store Card, Credit/Debit Cards, Student Card, Business/Credit Card, Prepaid Card or Cellular Phone by Internet payment Processors.

A paper printed receipt correlated to the trolley would be available at several exit locations when the trolley approaches and is in proximity to the receipt printer provided as a transitory momentary stop; alternatively an electronic receipt is deposited with the trolley CPU automatically following dispensation payment. As the shopper leaves the store with the fold-up stow-able trolley, and the standalone fix-packed semi-collapsible bins, having orderly unified contents within each of the color-coded, perforated, washable and reusable bins, product did not need to be disturbed or removed. These bins are also purposely configured to be stow-able in an upright perpendicular position. The enclosed purchased merchandise remaining confined in place precluded from tumbling-over. The bins remain stable in this as placed position during transit, eliminating any inconvenience of sorting upon home arrival; allowing expedient ease for in-home pantry stocking.

### DRAWINGS

36 Drawings:

FIG. 1-a. Typical Layout of a Food Retail Supermarket In/Out Egress.

FIG. 1-b. Typical Layout of a Food Retail Supermarket In/Out Egress.

FIG. 2-a. Orthographical projection of a 3-wheeled total fold-up shopping trolley.

FIG. 2-b. Orthographical projection of a 3-wheel total fold-up shopping trolley with collapsible bins overlaid.

FIG. 3-a. Side view of 3-wheel, fold-up larger push trolley lightweight support framework, 5-bin configuration.

FIG. 3-b. Plan view of 3-wheel, fold-up larger push trolley lightweight support framework, 5-bin configuration.

FIG. 4-a. Side view of 3-wheel, fold-up larger push trolley with installed 5-collapsible bins, color-coded, 4-standard, and 1-large.

FIG. 4-b. Plan view of 3-wheel, fold-up larger push trolley with installed 5-collapsible bins, color-coded, 4-standard, and 1-large.

FIG. 5-a. Side view of folding ‘fulcrum larger trolley cantilever beam’ showing bin clevis riser supports [5] with RFID Balun and sensor, harmonic & ultra-sonic connections with pre-stressed load cell linking tension pivot pin attachment; including retractable touch screen display and cell-phone cradle electronic interface.

FIG. 5-b. Plan view of folding ‘fulcrum larger trolley cantilever beam’ showing bin clevis riser supports [5] with RFID Balun and sensor, harmonic & ultra-sonic connections with pre-stressed load cell linking pivot pin attachment; including retractable touch screen display and cell-phone cradle electronic interface.

FIG. 6-a. Side view of 3-wheel, fold-up push smaller trolley lightweight support framework, 4-bin configuration.

FIG. 6-b. Plan view of 3-wheel, fold-up push smaller trolley lightweight support framework, 4-bin configuration.

FIG. 7-a. Side view of 3-wheel, fold-up intermediate push trolley with installed 4-collapsible bins, color-coded.

FIG. 7-b. Plan view of 3-wheel, fold-up intermediate push trolley with installed 4-collapsible bins, color-coded

FIG. 8-a. Side view of folding ‘fulcrum intermediate trolley cantilever beam’ showing bin clevis riser supports [4] with RFID Balun and sensor, harmonic and ultra-sonic connections and load cell pivot pin attachment; including retractable touch screen display and cell-phone cradle.

FIG. 8-b. Plan view of folding ‘fulcrum intermediate trolley cantilever beam’ showing bin clevis riser supports [4] with RFID Balun connections and load cell pivot pin attachment; including retractable touch screen display and cell-phone cradle.

FIG. 8-c. An expanded Load Cell Fulcrum point to the cantilever beam, showing the strain reluctance cavity nitrogen filled cushion, side view.

FIG. 9. Orthographic projection of a 3-wheeled completely folded up shopping trolley frame and fulcrum beam configuration.

FIG. 10. Consumer friendly shopper's flip-up touch-screen, advisory panel and store shopping companion.

FIG. 11-a. A diversity of side views, of client shopper's personal collapsible concertina bin, showing mounting depictions [in line trunnion to clevis] to the cantilever beam, also depicting Balun & ultra-sonic interconnection for the install holder assembly. The bins constructed of re-useable washable, nylon polyamide combined with polyethylene-molded insitu with rim Balun, reader sensors; including ribbed and all supplementary antennas.

FIG. 11-b. Plan view of shopper's personal collapsible concertina bin, mounting depiction [trunnion to clevis] with fulcrum beam depicting Balun & ultra-sonic interconnection and install assembly.

FIG. 12. Side view cross-section of shopper's personal collapsible concertina bin depicting BIN throat main BALUN AND induction supplementary RFID antenna arrays shown in the part and fully extended bins.

FIG. 13a-m. State diagram ‘registered clients’ showing in-situ trolley electronic functions, progressive shopping inventory, Balun transfer data via RFID/WLAN to Operations Center for database posting, scrutiny, payment and supply pipeline reorder.

FIG. 13-n. Shopping procedure depicting product merchandize removal from Balun deployed shelving racks.

FIG. 13-o. Continued shopping procedure depicting product merchandize reader scanning and position deposit into bin.

FIG. 13-p. State diagram showing database cataloguing of RFID tagged merchandise progression from the point of receiving, at the loading dock; to breakdown racking within the storeroom; to distribution allotment into the store; followed by selected procurement purchases by the client shopper; to final evaluated and reimbursement at the cashierless checkout zone.

FIG. 14. Trolley beam in-situ ‘Motherboard’ a main CPU shopping control center within trolley, real-time, RFID Balun aisle by aisle inventory take-down monitoring and reporting to Operations Center; with reconcile matching of non-flagged accrual leading to checkout phase.

FIG. 15. Trolley beam in-situ ‘Daughterboard’ a complementary auxiliary CPU used for reconciliation control between pre-stressed load cell, RFID Balun throat antenna reader, barcode reader, harmonic reader and magnetostructive-acoustic reader, all comparing weight to their product codes.

FIG. 16. Overview of store strategically placed Balun Gateways collecting and directing continuous monitoring of RFID data transfer via SkyGate WLAN nodes en route DirectGate linked network Operations Center at the Control Hub.

FIG. 17. Tangible location and deportment of advantageously zoned Balun linked-network.

FIG. 18. Enclave of Balun, WLAN, WWAN, TCP/IP, and Ethernet combined linked-networks for in-process operation and payment-selected choice.

FIG. 19. Overview summation of dispensation Intranets Ethernet, WWAN, Internet and Cell-Phone interconnectivity links for TCP/IP global processing.

FIG. 20-a Typical Active Portal at all Store Egress Locations including Loading Docks & Staff Man doors.

FIG. 20-b Active Antenna Loop Matching Link-Network for Doorway Portals.

FIG. 21-a Pictorial View of Client Shopper Route Through Aisle Passing Various Shelves Mounted and Store Mounted Balun Zones.

FIG. 21-b Various Store Mounted Active Balun Formats Strategically Mounted Throughout Store within Various Zones.

### BEST MODE FOR CARRYING OUT THE INVENTION

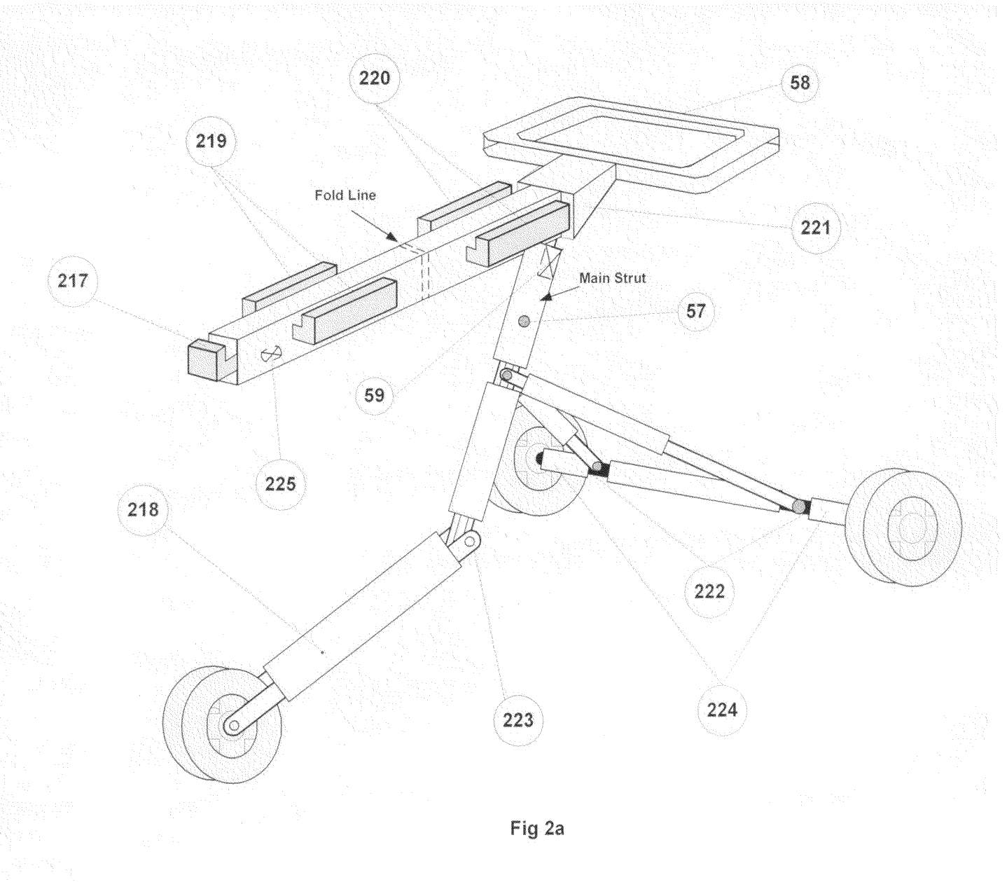

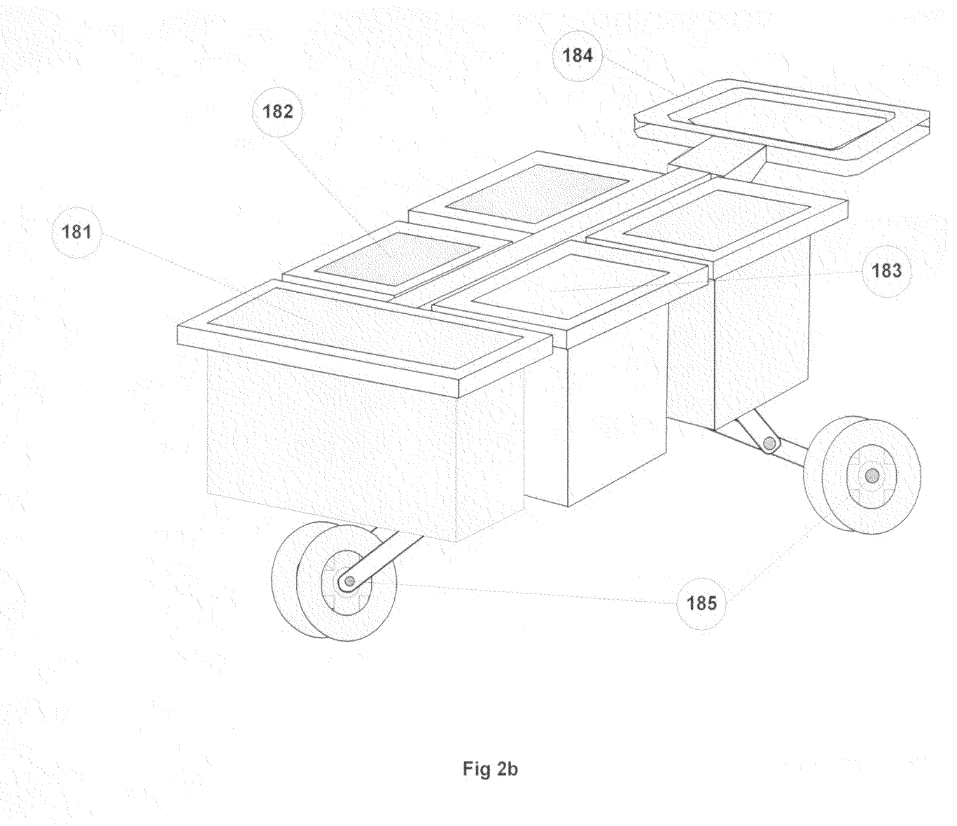

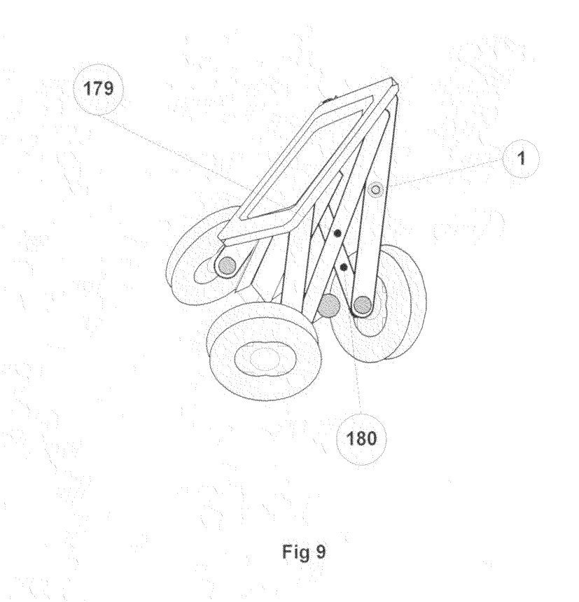

Upon arrival at the supermarket store to shop, primarily the folded compact lightweight, three wheeled trolley shown in FIG. 9, is out-loaded from the shoppers transportation means, whereupon by depressing the detent opening button 1, allows the preloaded mechanical enclosed helical compression spring, coupled mechanisms 180, with revolving joints 179 that allows the trolley to rotate and unfold open; as orthographically illustrated in FIG. 2a, becoming appropriately fully and rigidly unfolded upright.

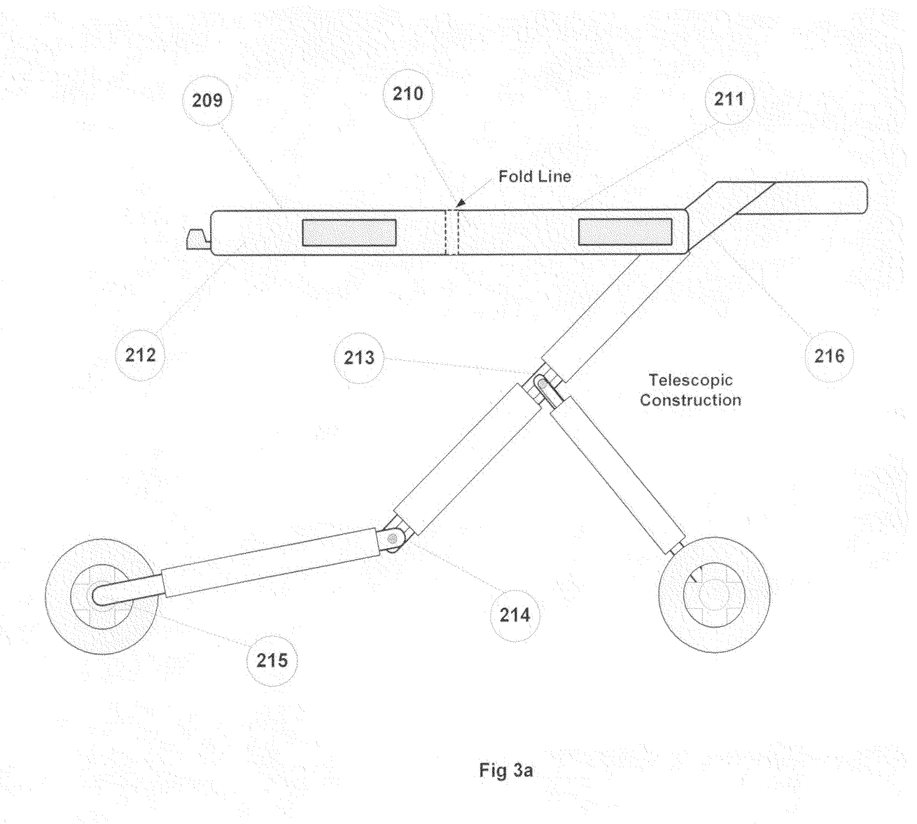

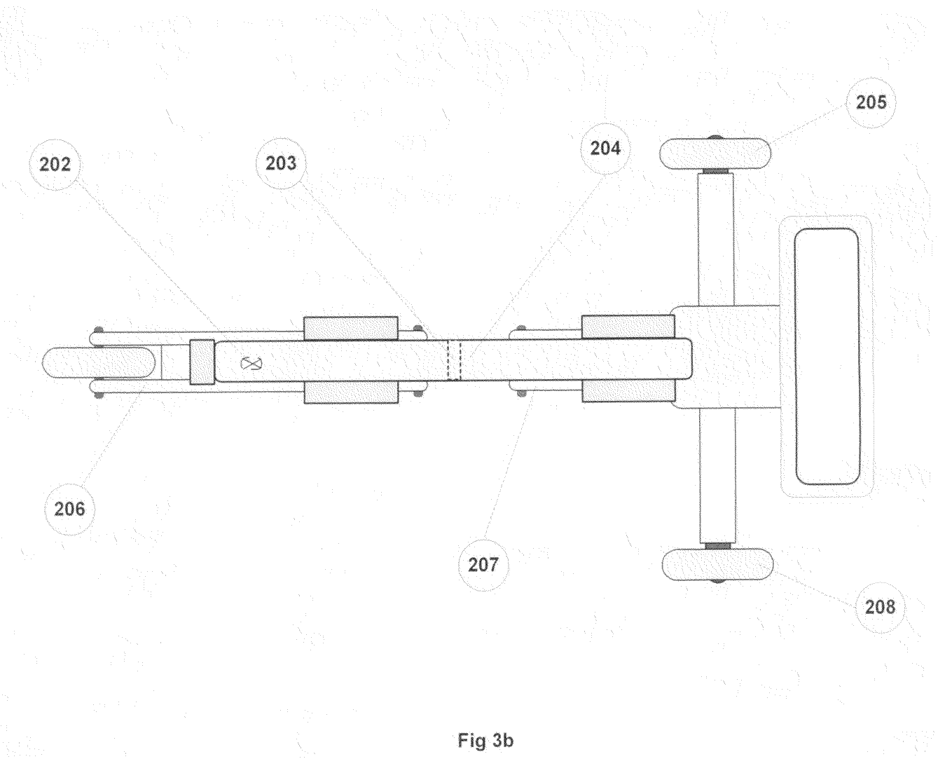

This trolley one-piece assembly is mechanically securely brace-interlocked 222, 223; above its main-strut constituent support 57 with the cantilever beam locked against the kingpin in the horizontal level position; showing the bin mounting trunnion brackets located at the end and either side 217, 219, 220. The handle fold over latch/unlatch pawl-ratchet 221 and forward long sliding toggle 218, including rear wheel spacer sliding-locks 224, that bolster bracing of the unfolded trolley state. The side elevation shown within FIG. 3a, locates positioning of the ‘Motherboard’ 211 and ‘Daughterboard’ 210 insitu, is totally enclosed within the cantilevered beam, including locations of the active RFID Balun loops 212 and additional sensor readers 209. The forward folding linkage joint is shown 214, second sliding compounded folding toggle linkage 213 and trolley pushing handle adjustment 216; with situation of the solid rubber butadiene leading nose wheel 215. Referring now to FIG. 3b indicates positioning of the battery nest 202, telescopic compound compression, cantilever beam slide 203 at each side of the fold-line 204, arrangement of nose wheel support bracket 206, spring loaded clevis pin insert 207 with rear butadiene trailing wheels 205 and 208.

This sturdy plastic, unfolded three-wheel trolley with its installed suspended bins assembly hung assortment shown insitu is coupled with the trolley base frame structure FIG. 2b, having by advantage of design being a significantly low center of gravity due to lessening of bin lower base elevation levels, 181 depicts larger bin wide end transverse outline, with the both smaller bin right-side pair, 182 and both smaller bin left-side pair, all positioned longitudinally 183. With an ergonomic slightly [two-degree] upward angled handle 184, shock absorbent handle covering making the trolley comfortable and easy to push and steer, partially or fully loaded due also to all three-wheels width positioning and configuration 185

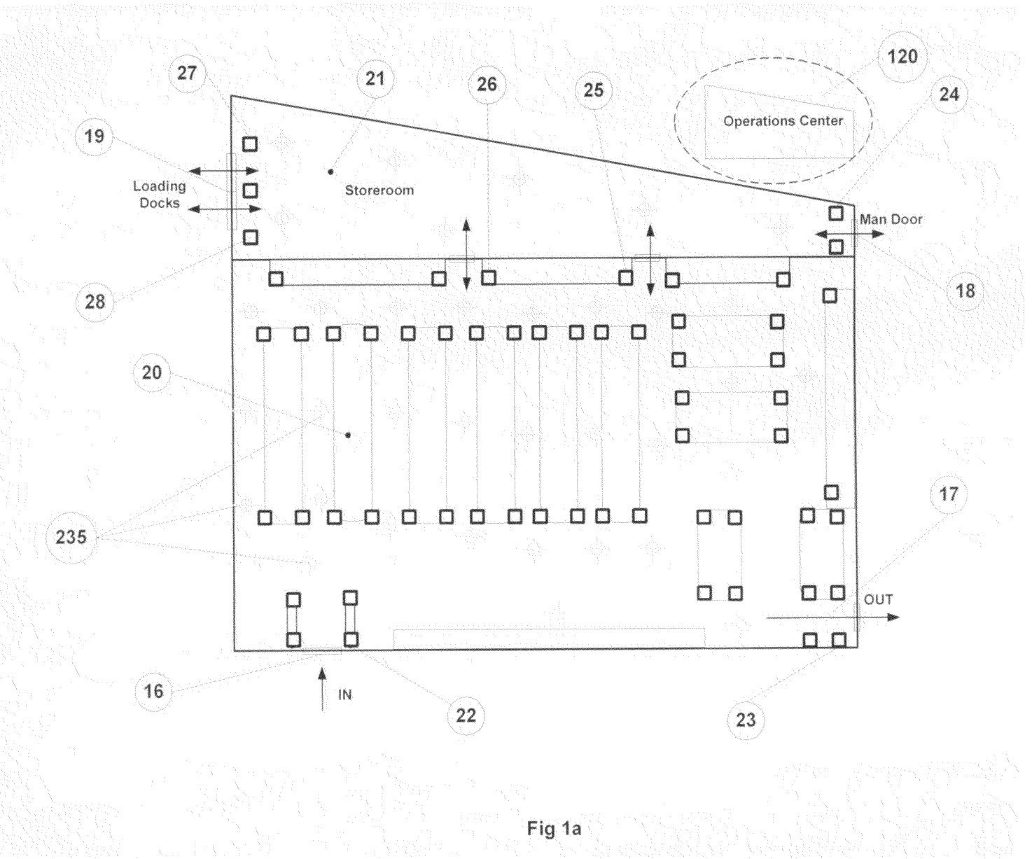

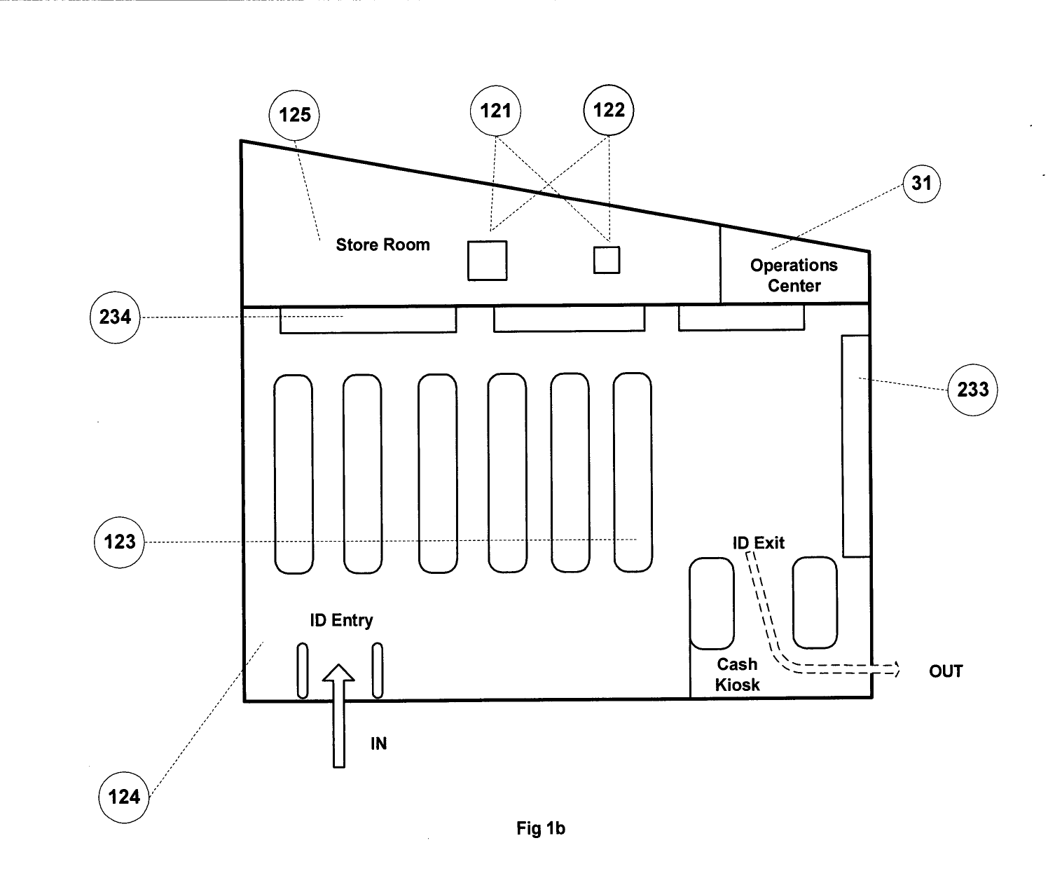

Referring to FIG. 1a which depicts a typical store layout showing a conventional ‘Operations Center’ 120 and FIG. 1b locating Network Operational Controlling [NOC] Links 31 in conjunction and association with controlled main egress entrance 16, the client shopper's trolley upon arrival is recognized, PIN acknowledged and accepted at the entrance authentication zone 124 allowing client trolley to be calibrated and checked with empty bins in place. Further in conjunction and association with controlled main exit 17, additionally in further conjunction and association with controlled main loading dock grouping 19, with and in further conjunction and association with controlled man door 18, [note: fire escapes which are already enunciation and warning alarmed are not shown] to the entire store vicinity generally identified. The main store district 20 and storeroom zones 21 include a plurality of pass-through and move-between egress electronically administered portals, all these egress portals installed with a selected array of sensors comprising Balun pair antennas, could also include and may comprise grouped ‘ultrasonic, harmonic, and magnetostructive-acoustic reader sensors 22, 23, 24, 25, 26, 27, and 28 interconnected with layered WLAN link nodes 235.

Made known in FIG. 1b is a plurality of merchandise shelved aisles prearranged as a vicinity electronically scrutinized sectors 123, and for a variety detached produce counters comprising miscellaneous and various food stuffs in open containers such as bakery goods, refrigerated goods, frozen goods, green groceries dairy and meat stuffs 233 and 234 areas. Notably, the storeroom 125 sectors comprises a plurity of aligned racks 121, within the storeroom the unloading portals are active Balun or sensor monitored, equally racks the shelves are equipped with active Balun antenna loop sets for arriving merchandise recognition and cataloguing. The inventory record is updated; cross-matched with reorder and reckoned against the loading dock door sensors, further reconciled by shelf sensor arrays, as merchandise is broken-down, later removed and transferred to the store. This system provides a batch time stamp, quantity record of the particular removal and transfer 122. Within the storeroom and store district areas proper the identification-monitoring portals established within the system a procedure of registration and cataloguing of all merchandise and merchandize movement into the said storeroom, then into the said store and into the said shopping trolley bins.

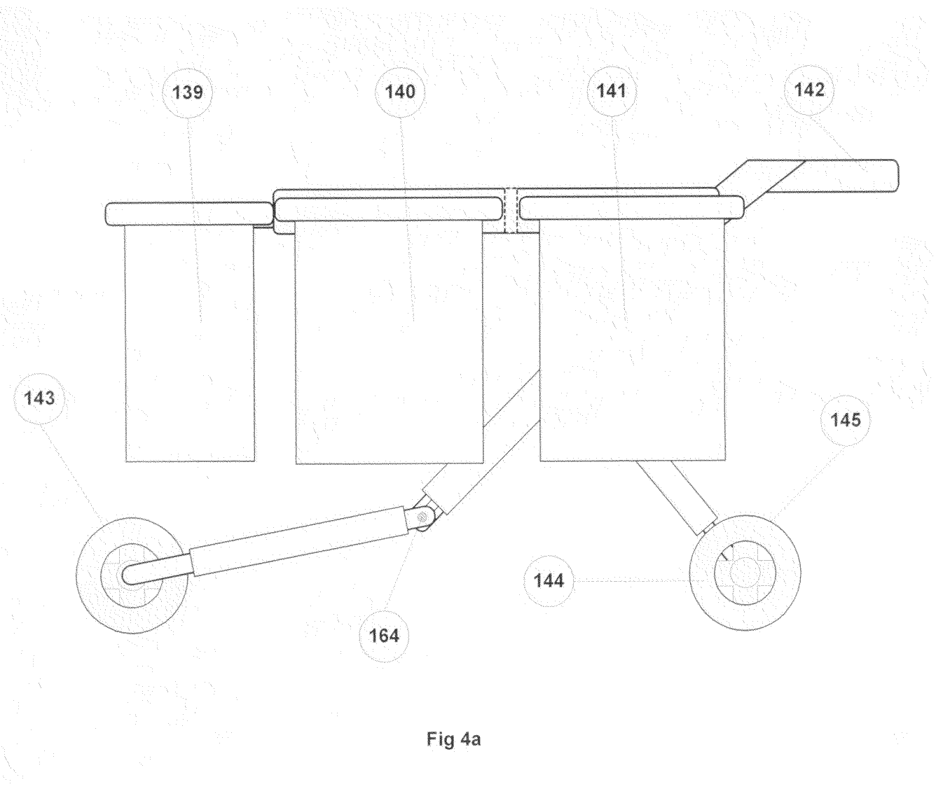

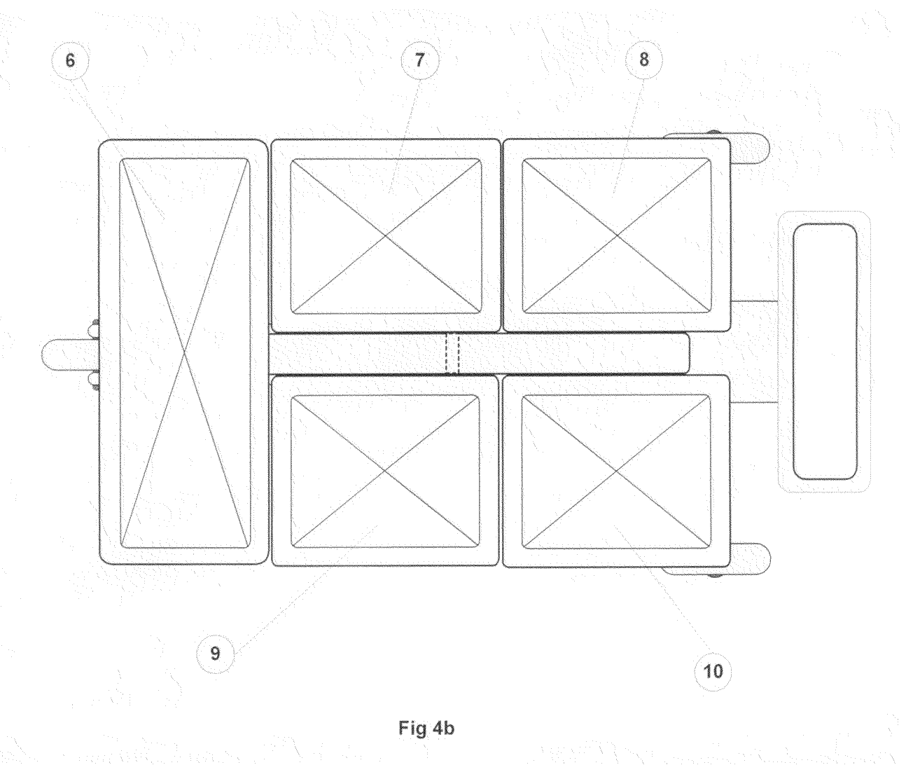

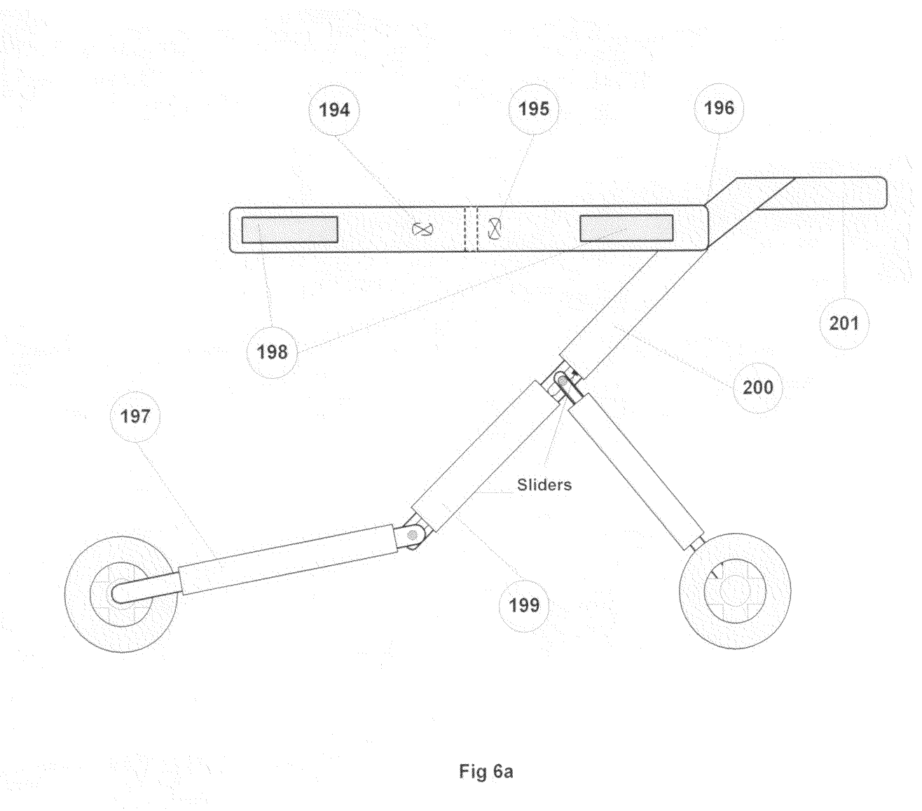

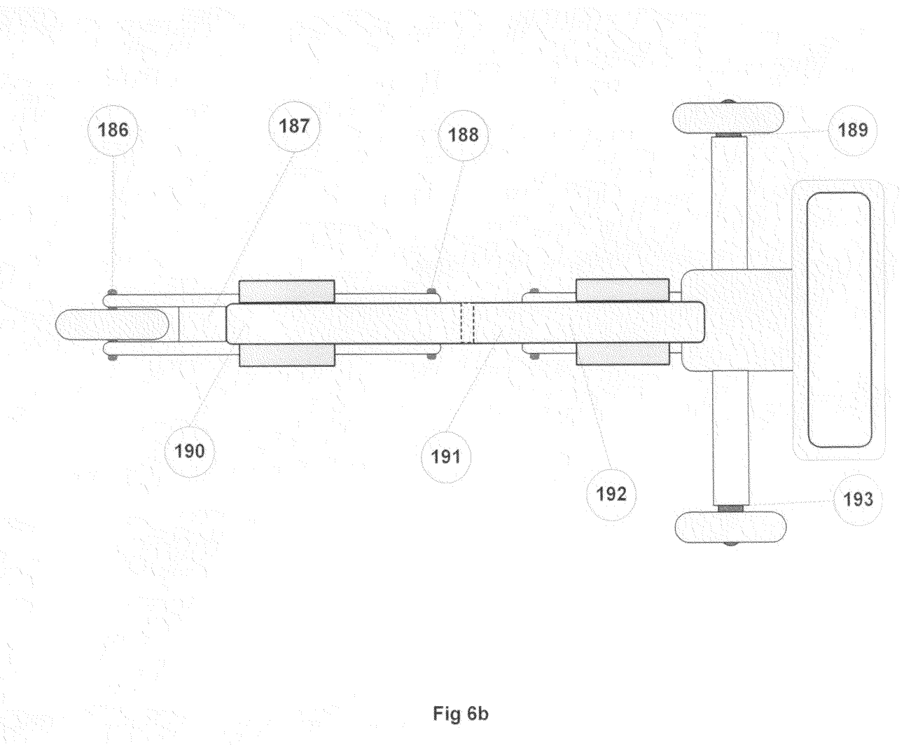

In FIG. 4b the 5-bin assembled and positioned versions are shown as items 6, 7, 8, 9 and 10 in plan view. In FIG. 6a, the battery interconnection main terminal bus-supply point, as distribution to all enclosed cantilever beam auxiliary electronic components and boards 194, position of the folding cantilever beam hinge locking détente 195 and handle pawl ratchet release latch 196. The sliding bin rim clevis mount positioning is shown 198, which also interfaces with the active Balun rim connection. The tubular lower housing truss 197, interconnected to the rotating joint tubular intermediary housing slide and latch 199, together folding upper main strut slide and latch 200; the neoprene/latex rubber pushing and steering handle covered handgrip is shown 201. Furthermore in FIG. 6b the wheel bearing spindle is shown with fastening 186, including front wheel folding fork shroud 187, with upper eccentric locking slip-ring position 188, left-right wheel bearing spacer 189 and 193, with position of the internal slip clasp folding lock 190, the internal fold-down, pawl locking ratchet 191 and 192.

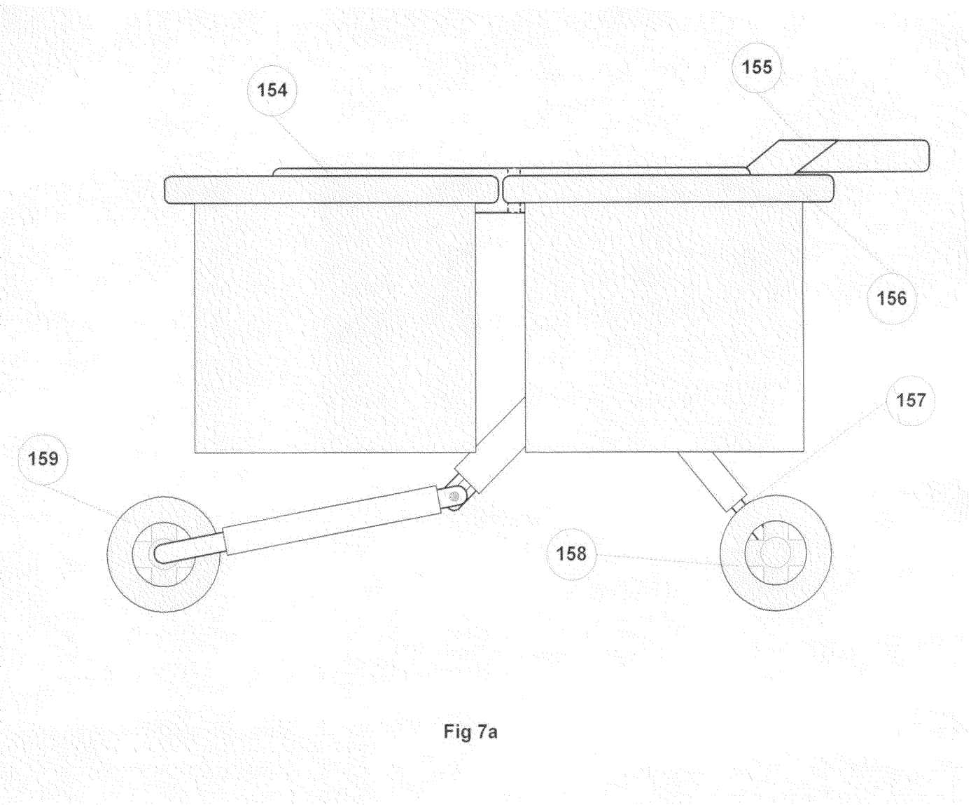

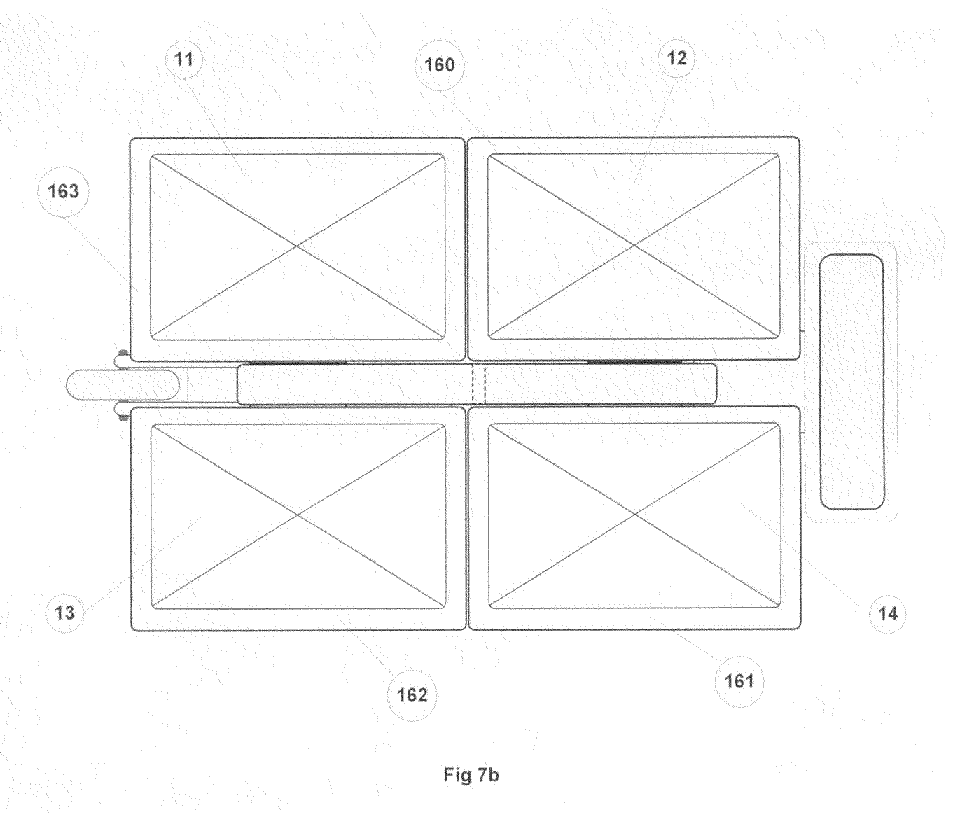

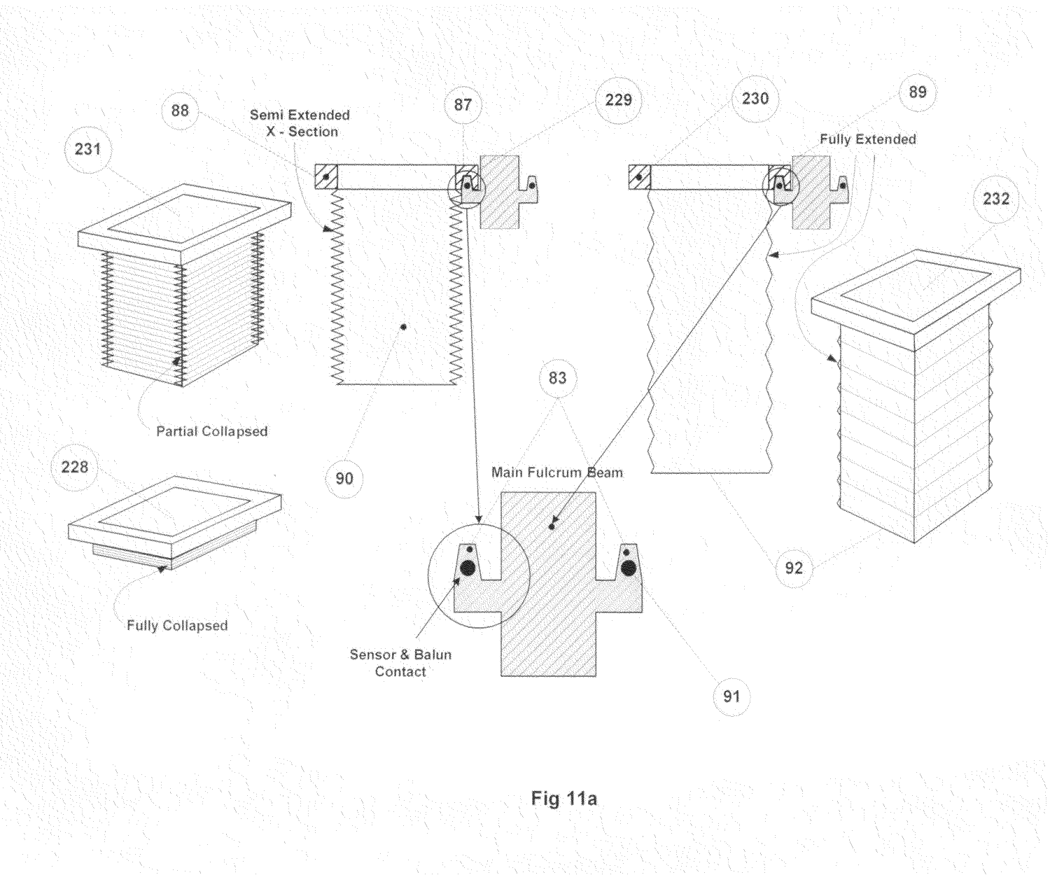

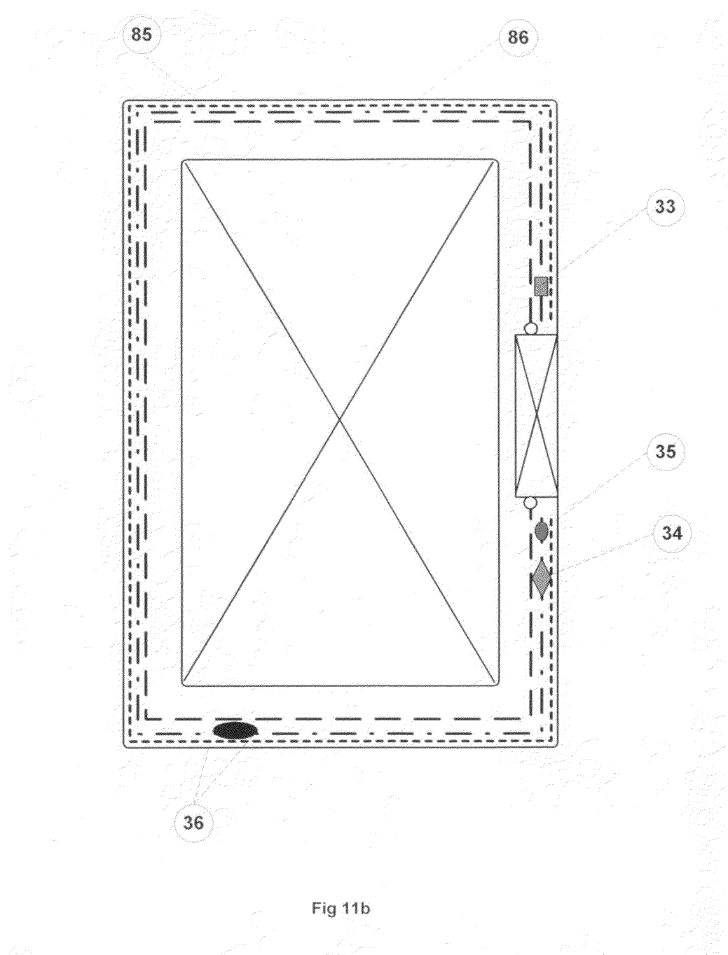

In FIG. 7b shows in the 4-bin version plan view 11, 12, 13 and 14 respective situation of the assembled bins extended into their relative upright positions. The collapsible telescoped bins, when not in use, may be conveniently stacked and stored for transport These bins are color-coded, and of concertina form-type depicted in detail in FIG. 11a, are manufactured from nylon polyamide combined with polyethylene, forming of a tight mesh material fabric typically 90, supported by the rim brim carbon filled polycarbonate/acrylonitrile butadiene styrene support typically 87, with encapsulated [insitu molded] Balun antennas and other reading sensors 88, rebate clevis contoured into the cantilever beam retaining trunnion shown both sides cross sectional view 83, with electrical connections contact terminals shown 91, each bin has a much stiffened heavier gauge fabric material underside base substructure 92; a Morse taper #5 that interfaces with bin supports and trunnion clevis lip interface 89.

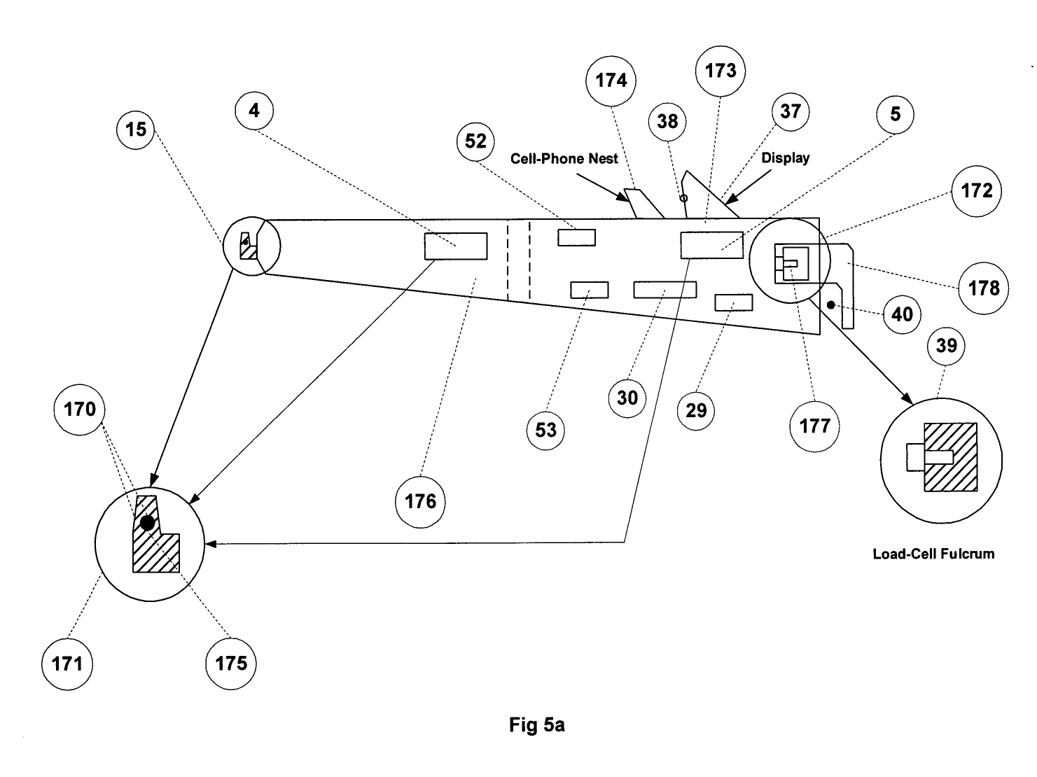

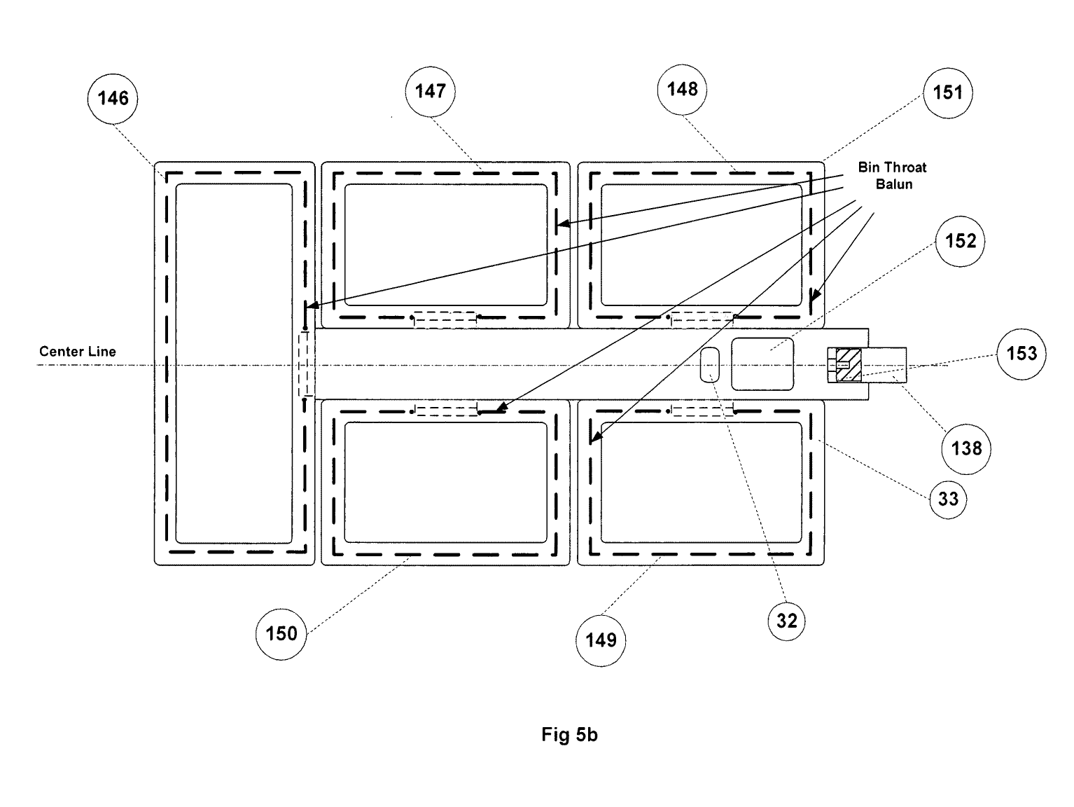

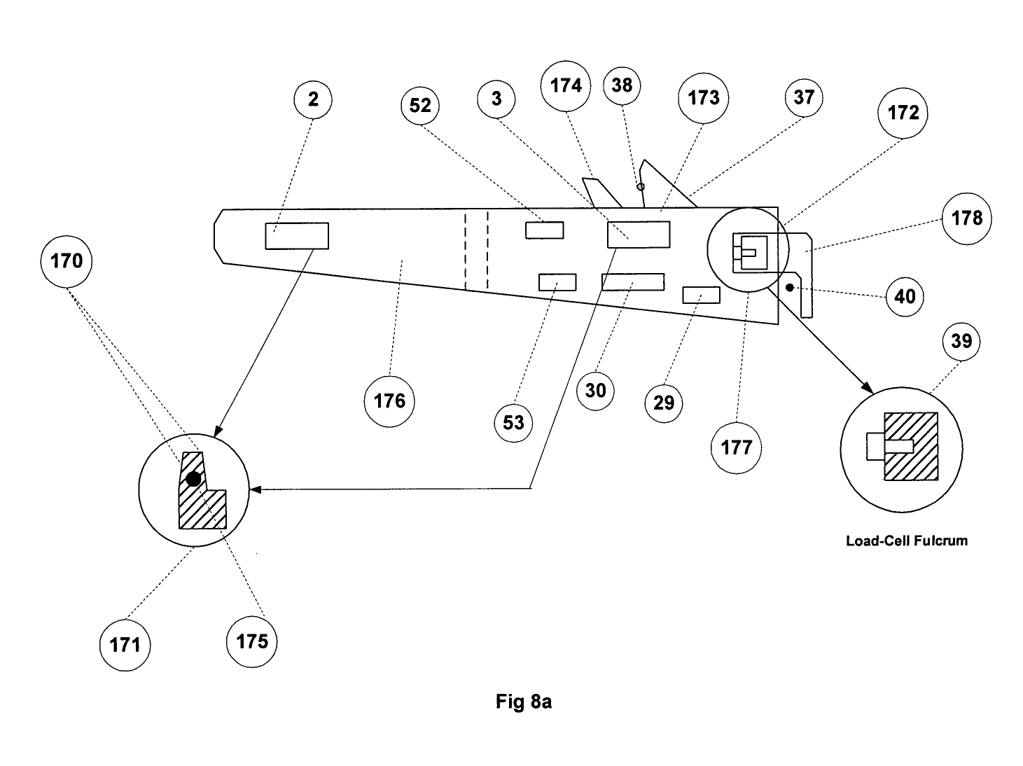

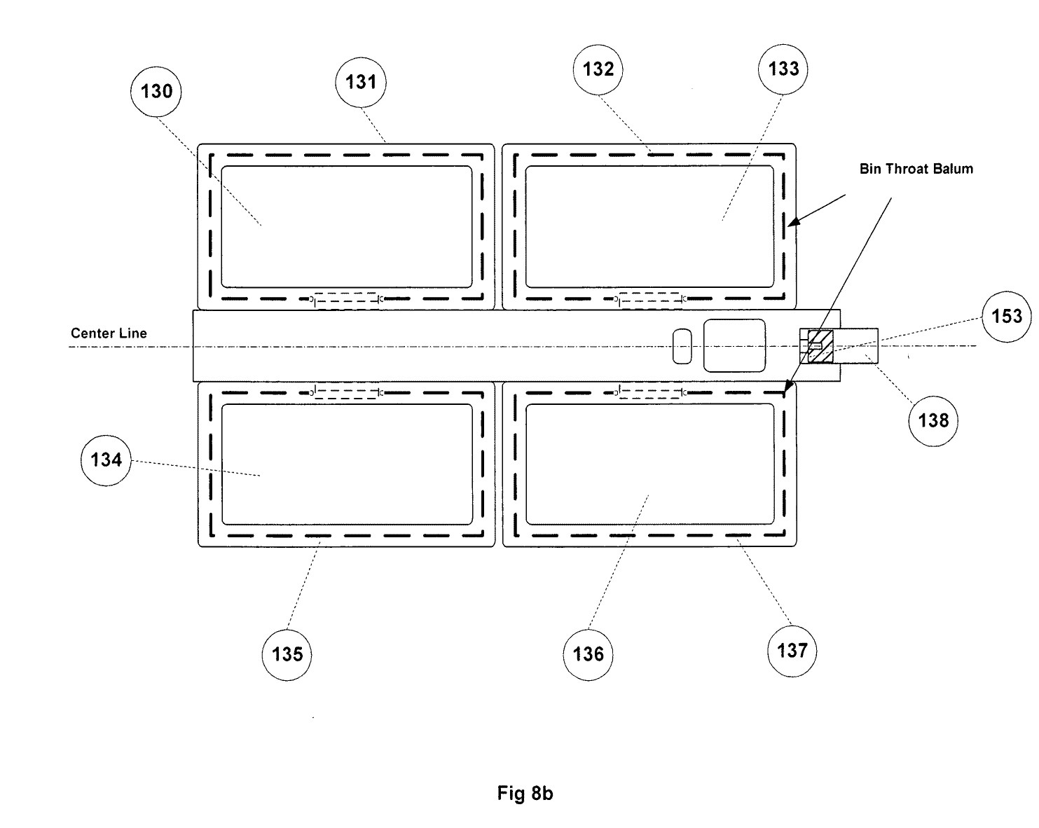

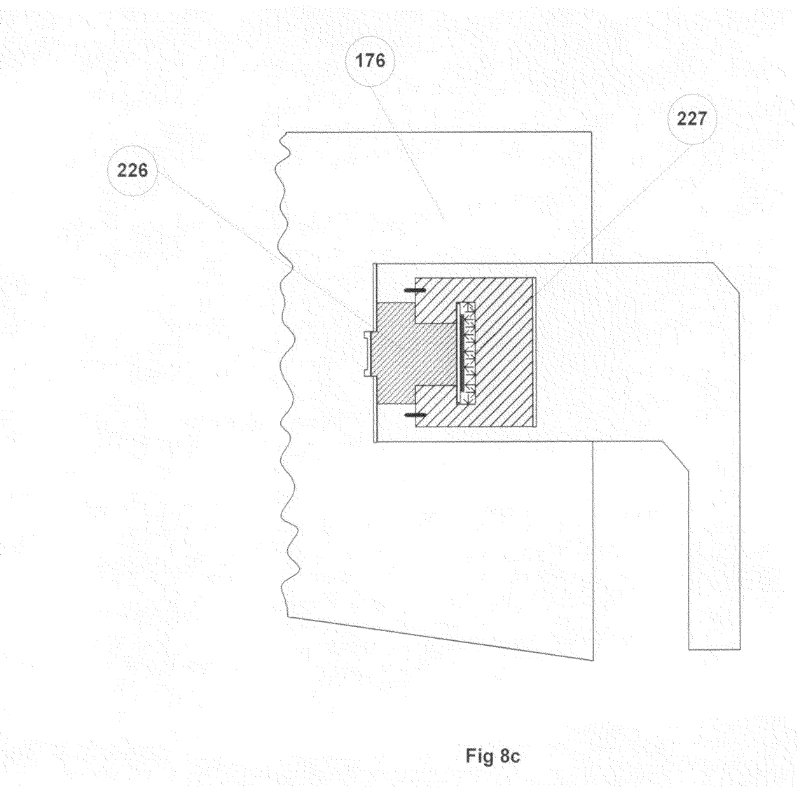

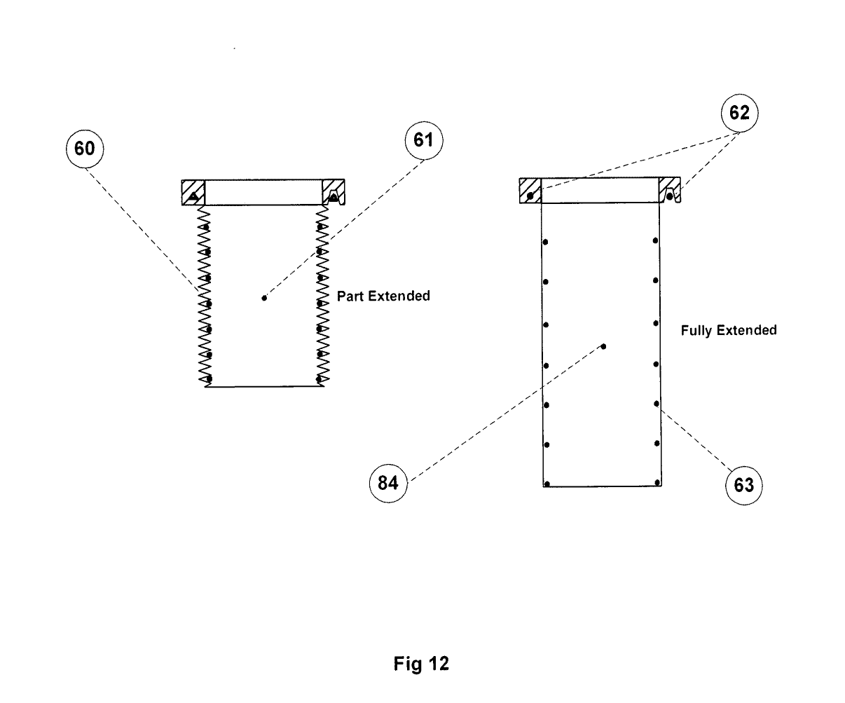

Within FIG. 12 shows a concertina bin with encapsulated supplementary antennas arrangement 60, the partially closed convoluted cross-section 61 and the same bin fully extended 84, show the various spacing of the supplementary antenna elongated gaps 63 and the upper Balun continuous loop sensor with contact pin 62 placed for connectivity respectively onto the beam trunnion supports shown as 175 in FIG. 5a and FIG. 8a respectively depicting cell phone connectivity holder 174.

Further also in both FIGS. 5a and 8a a cantilevered beam 2 constructed from carbon filled polycarbonate/acrylonitrile butadiene styrene cantilevered beam 176 and bin carrying construction incorporating a pre-strained load-cell assembly 177 expanded in further detail FIG. 8c The beam is pivot secured to the main strut by a fulcrum hinged restraining precision hook and eye fastening 178 swivel retained through a hinged ‘king pin’; also depicted are the retractable latch-down clip 173, load cell electrical connection 172, the slide-on contacts for suspended bin mode, for both the four or five trolley bin configurations 170 in expanded view 171. The trunnion carrying supports on each assembly-side including the one end-assembly 2, 3, 4, 5 and 15. The more comprehensive fast read pre-strained load-cell view is depicted in FIG. 8c; this shows the fulcrum bearing configuration in respect of the cantilevered beam loading, having a nitrogen filled dampened and stabilized transverse precision housing eliminating all anti-sway influences, this system as opposed to a ‘Wheatstone-Bridge provides a flash fast read inductive/reluctance gauging means, being also insensitive to North American temperature variations.

The trolley and client shopper's peculiar code, having been system identified with the appropriate PIN number acceptance, is further re-established by the calibration mode in the ‘Motherboard’ 30 secure CPU via the ‘Daughterboard’ 29. The trolley active RFID Sender described in FIGS. 5a and 8a are also totally enclosed within the cantilever beam construction. Therefore, upon store entrance the trolley is ‘polled’; identified and following the response signal from all trolley reader, approves admission, displayed visually and audibly on the opened retractable display 37, which also incorporates the barcode reading head 38. These electronic devices and processing apparatus are housed and interconnected within the trolley cantilever beam. At this point of the shopping phase the load cell having been appointed is automatically set to a ‘0’ [zero] recalibration taking into account the exact tare weight compared by the Operations Center NOC to the last visit, that is after trolley positioning with the bin variety selected, empty and situated on the cantilever beam, retained on the ‘king pin’ to the hook and eye 40 mechanism. If desired this authorization data and time stamp may also be communicated to a suitable docked and connected NFC smart cell-phone at 174 on the trolley. These steps then allow commencement of the shopping agenda to begin; the client shopper's trolley may now enter all aisles and sectors, moving freely throughout the plurality of active RFID Balun loops monitored shopping districts 20 and throughout other chosen and monitored store areas.

As is well known shoppers walk freely throughout the store and select the items they choose for purchase. Referring now jointly to FIGS. 5a, 5b, 8a and 8b, the sensor antenna loops, encapsulated into the rims of each of the four configured bin rims 131, 132, 135, and 137 and each of the five configured bins rims 146, 147, 148, 149, and 150, where each bin throat has a similar form and sensor content as 151. Shopped merchandise items after being bin deposited, are all passive coded with either current barcode, or alternatively RFID tags or alternative ‘ultrasonic, harmonic, magnetostructive-acoustic’ readers, will be recognized when placed and deposited into a bin having passed through the throat of a respective bin. Whereas an un-coded, tamper changed or irregular-mismatched item attempted to be loaded into the bin similar cavity spaces 130, 133, 134, and 136 will prompt an alarm flag; since the load-cell integrity was not able to trigger. The loadcell fulcrum assembly 177 retained against the king pin housing 138 which incorporates the nitrogen gas filled cushion 153 having instantaneously detected an error prompting a weight flag and alarm at the CPU, which will not accept further merchandize until this flag is cleared promptly by the client shopper, being observed and ‘enunciated and audio alarmed’ at both display and Operations Center; requiring override and reset. The discernible, connected and retractable touch screen display 152, or NFC smart cell-phone nested and RFID contact or wirelessly connect docked 32 are openly connectable and accessible. Further detailed in FIG. 8c is an expanded cross-section 226 of the intrinsically cushioned, sealed, pre-strained load-cell with inductive reluctance cavity that is nitrogen dampened, insensitive to normal weather range North America temperature variations 227.

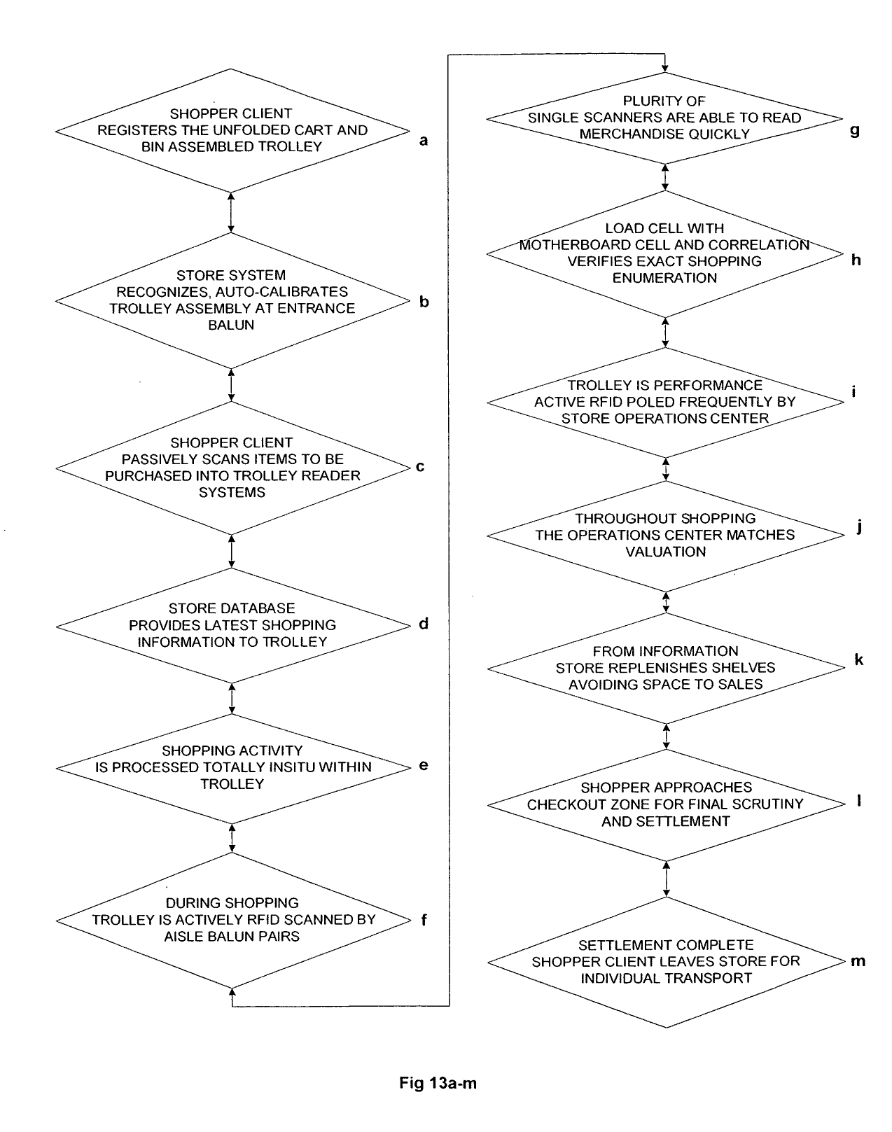

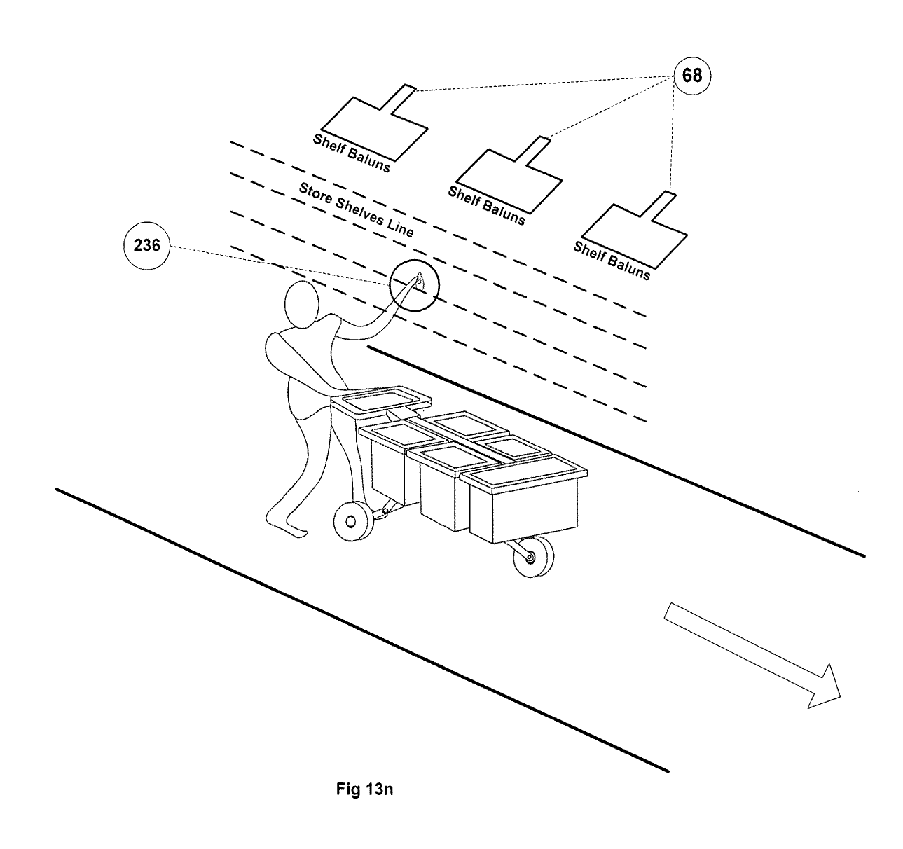

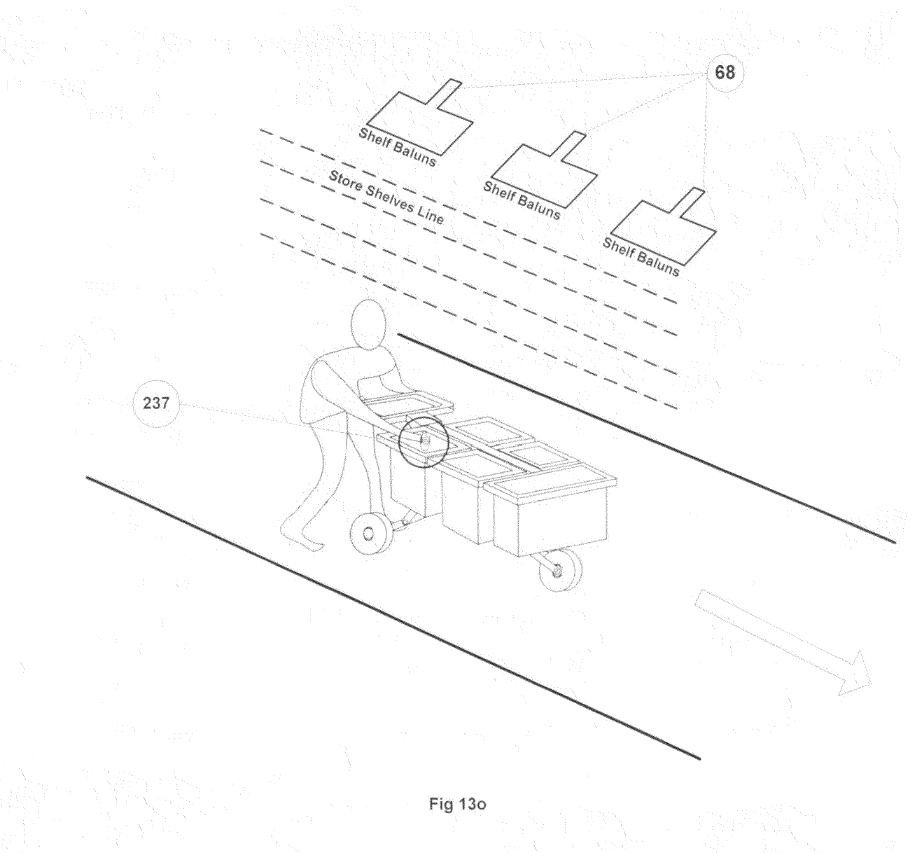

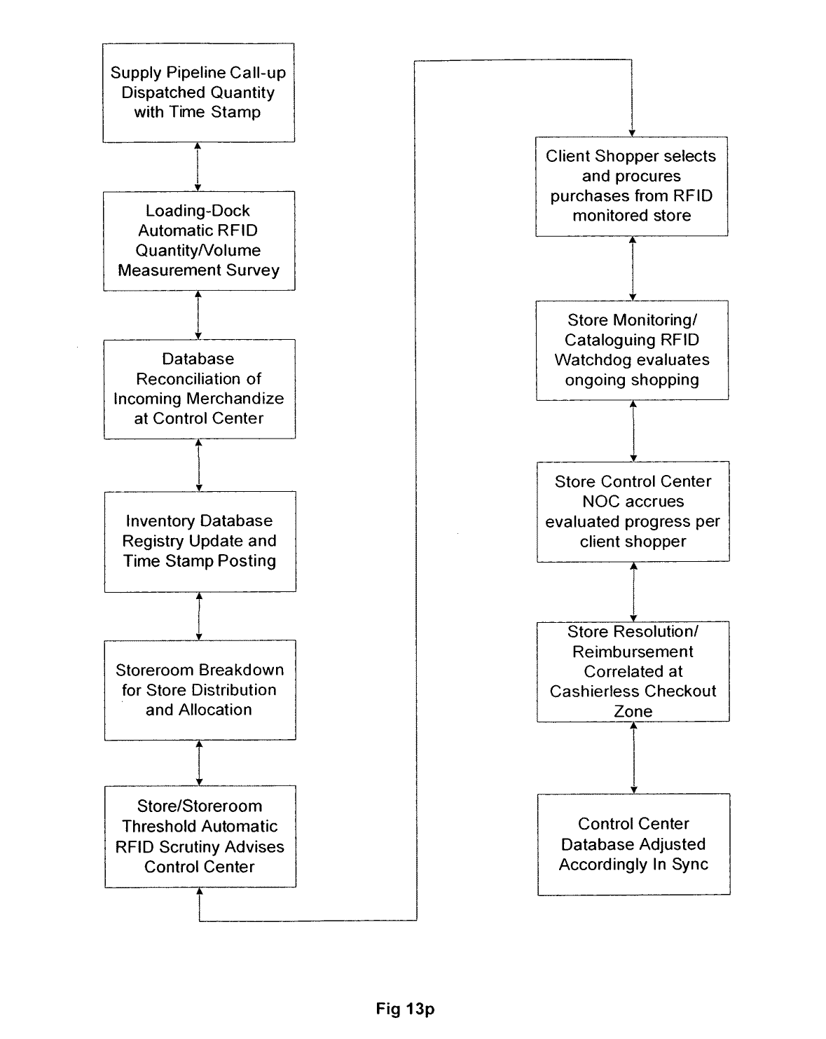

Passive Balun reader 33 Shown in FIG. 11b and FIG. 5b which may also coalesce with a plurality of other encapsulated bin sensors, an ultrasonic transducer 34 a ‘magnetostructive-acoustic reader 35 a harmonic frequency receiver 36 with two supplementary arrays 85 and 86 to detect dual or triple simultaneous product entry. In the event bar-code tags are being utilized a laser bar-code reader 38 also remains available, shown insitu within the retractable display 37 in FIG. 8a, maintaining this alternative existing method. A pre-stressed load cell FIGS. 5a and 8a distended view 39 interconnected to the Daughterboard 29 is activated when product items are passed by either of the plurity of bin readers or barcode reader and placed into respective bins further typically exhibited in FIG. 13-n and 13-o.

Power supply, charge capacity using 4×U2 NiCad for trolley electronics will last on average, for once a week shopping up to, two plus year cycle, low battery signal is eventually sensed well before time at the touch screen display; an RS 232 port is placed conveniently for the shoppers home PC updates and shopping list as required in the trolley CPU FIG. 2a plug-in adaptor 225.

Referring now to FIG. 4a shows side elevation of installed bins hanging in their assembled position 139, 140, and 141, with the deportment of the three wheels 143, 144 and 145 touching the floor all at the time sanctioning solid stability. The push-pull thrust centerline 142 is purposefully upward slanted two-degrees positioned for easy routing guidance; since the wheels tapered oilite bearings only moderately steer 158, 159, however, certain comfortable minimal direction changeability is provided through the slightly flexing reinforced leading compression frame knuckle 164. Further shown in FIG. 7a the lightweight trolley frame, 155, 156, and 157 comprising hollow tubing that permits internal compression for telescoping fold-up to trolley limiting stops 154; upto the cantilever beam interleaf fold position from the fold-line. Again in FIG. 7b illustrates the convenient access to the trolley bin from a plan view with access positioning 160, 161, 162, and 163.

As shopping events advance within the store shopping zones proper there is a plurality of spaced rows of shelving as distinctively shown, typically for instance in aisles 20. Non-perishable items are placed on the shelving where shelf Balun Antennas are deployed 68. Bordering the rows of shelving are coolers, refrigerators and freezers holding perishable items such as meats, vegetables and fruits where a plurity of Balun mounted Antennas are deployed 66. As is well known, shoppers walk through the shopping store and selecting items to be purchased as shown typically in FIG. 13-n and FIG. 13-o respectively passing and placing these items through the throat of the individual color-coded bins, wherein these passive coded items are actively read by a single or plurity of throat sensors encapsulated within to the bin throat neck; additionally any subsisting barcode items are passed by the barcode reader the then conclusively placed onto the base of the bin where it is weighed. The accessed data from the reader sensors and the load-cell weight measurement is now evaluated, collaborated within the trolley, by the trolley CPU where it is stored and this stored data is then available for all for ongoing ‘poled’ comparison computation by the Operations Center NOC where this data is again stored. If there is a sudden removal of an item it is detected and recorded in both in the client trolley and store Operations Center NOC for future comparison at the checkout zone. If an item is placed at any stage of shopping indecipherable by the readers, into a bin the client's trolley and Operations Center immediately flag the error that must be cleared as previously mentioned to continue.

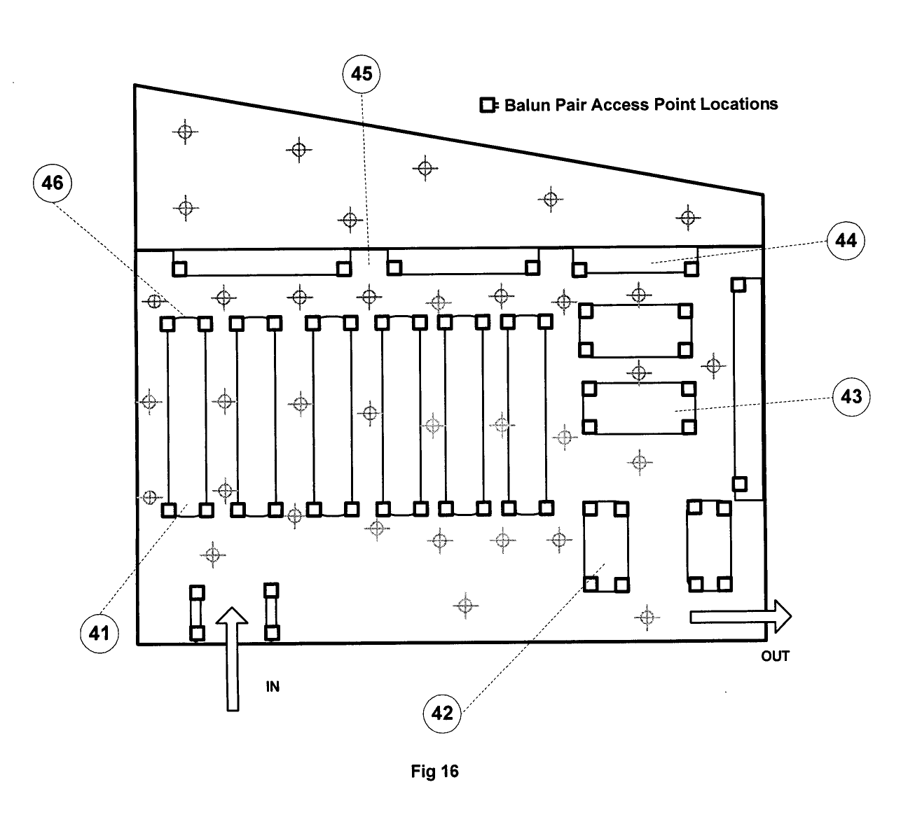

An overview of a store strategically placed active Balun/Sensor end-node loop pairs 41, 42, 43, 44, 45 and 46 are arranged in a general concept of a typical store configuration shown in FIG. 16, these Balun pairs actively RFID ‘pole’ each trolley as it passes by obtaining interim shopping quantified information downloads of all prior trolley collected data. Additionally, this ‘intelligent system’ will be intermittently interval ‘polled’ by Operations Center ‘on automatic cycle’ to ensure all end-node Balun pairs are fully operational, occurring in milliseconds of time and unnoticeable by shoppers or store staff.

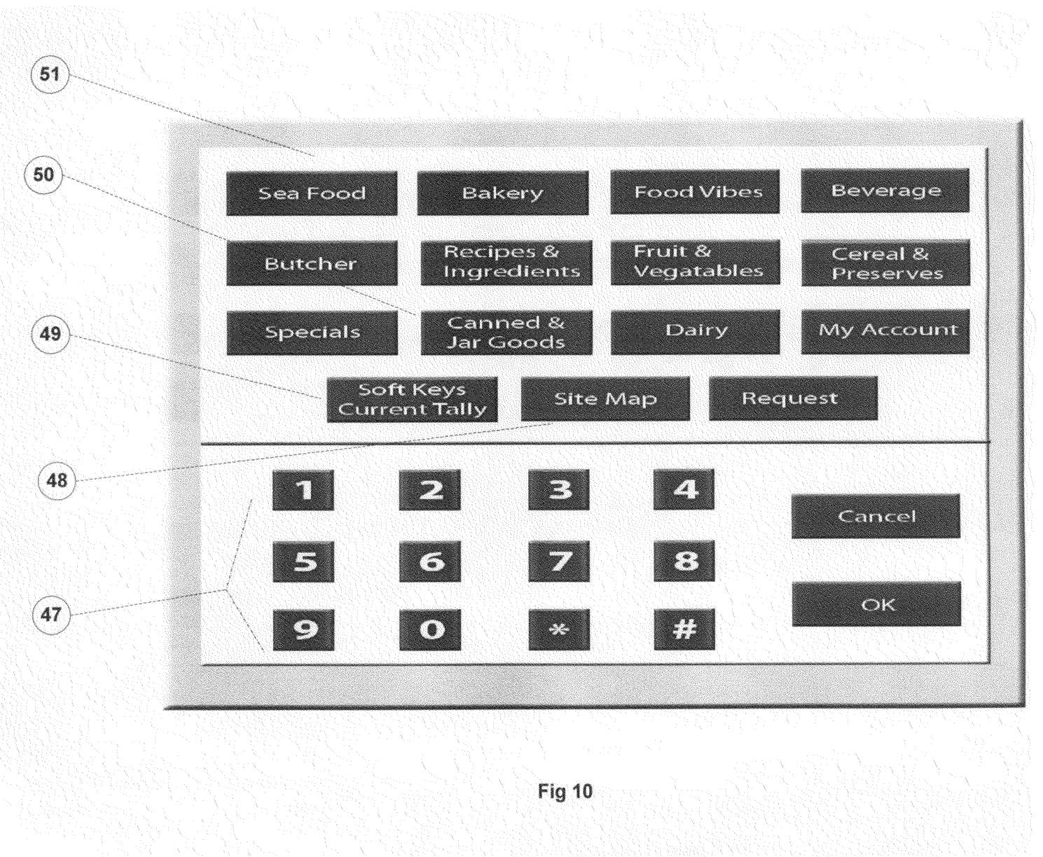

The touch screen ‘roll-over’ display monitor FIG. 10, includes a numeric pad exhibit 47, site map, presenting a visual plan and location of store produce locations, specials, rewards and text instant announcements; 48 is a shopping running tally with additional call-up designated soft keys, 49, with representative glyphs and icon attractions, also 50 designated ‘specials’, ‘my account’, and requests;’ also all purpose 51 ‘sea food’, ‘bakery’, ‘butcher’, ‘fruit/vegetables’, ‘dairy’, ‘canned goods/preserves’; and ‘cereals’ types.

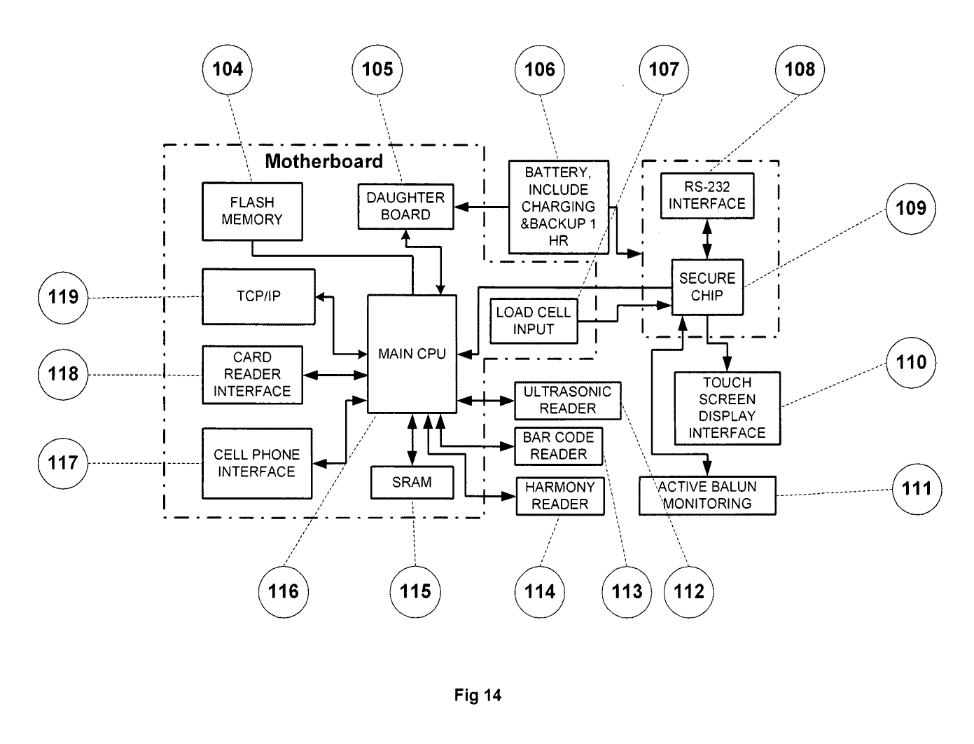

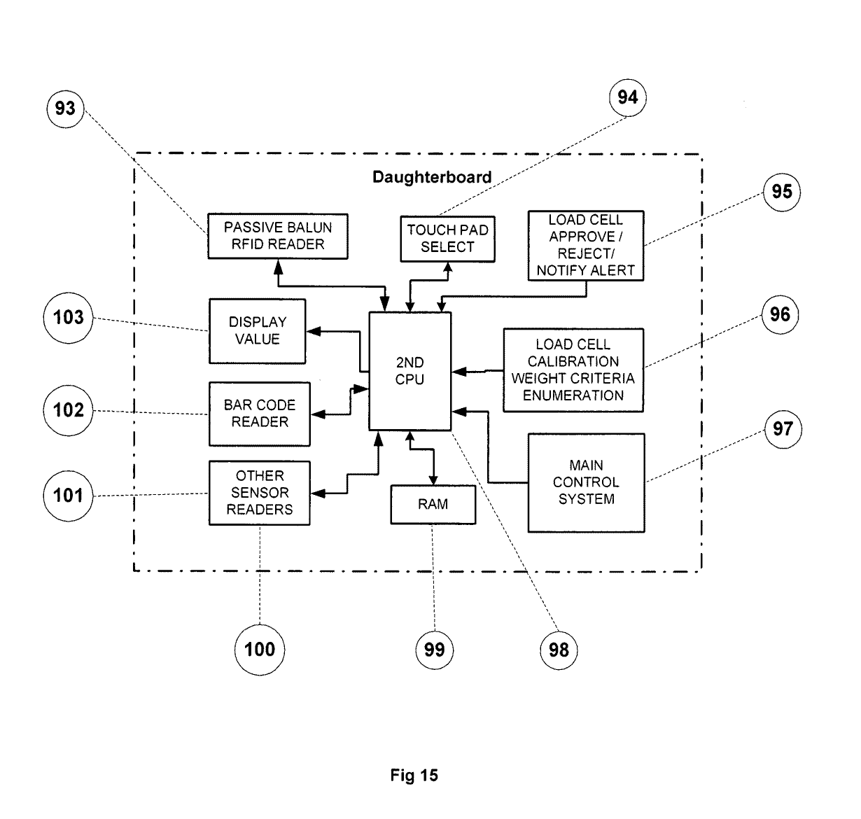

Within the wireless shopping trolley FIG. 14 the ‘Motherboard’ on which the internal electronic components of the RFID and WLAN store layered intranet links are mounted include the internal electronic component titled blocks 104, 105, 106, 107, 108, 109, 110, 111, 112, 113, 114, 115, 116, 117, 118, and 119 on the main CPU module board with secure module TCP/IP for protection reasons. Interconnected the secondary module FIG. 15, ‘Daughterboard’ includes a passive RFID and indirect store layered intranet link data interfaces connect [through the Motherboard 105 interface] integrated linked networking junction with laser bar code scanner components 93, 94, 95, 96, 97, 98, 99, 100, 101, 102 and 103. The main central processing unit [CPU] is connected to the interfacing Operations Center duplex Tx-Rx integrated junction. The ‘Motherboard’ contains ‘flash memory’ and ‘static random access memory’ (SRAM) with the secure chip, which is also wirelessly connected to the CPU for the store Operations Center start-up routines, I/O routines, application of administering programs.

Referring to the ‘Motherboard’ secure module, data instant eradication safety measures, which also provides cryptographic services and security to guard against, intrusion software tampering; that would also eliminate access to personal identification numbers (PIN) or passwords. The secure module includes an encapsulated one-time programmable (OTP) secure integrated circuit (IC) device with an auxiliary RS 232 interface; the secure IC device includes within the CPU read only memory (ROM), random access memory (RAM) with keypad FIG. 10 wherein 47 display interfaces respectively to allow the secure IC device to control operation on the display keypad. The ROM stores a secure operating system comprising cryptographic security services; display and keypad control and communications control with the main module. The RAM stores cryptographic rolling keys and passwords and provides for operating system administration. The main and secure modules receive power from the rechargeable battery 52 in the usual manner FIG. 8a. A backup battery is provided to protect against inadvertent power loss and consequent loss of data stored in SRAM and RAM. A photo sensor and internally spring load disposal contact FIG. 8a is also provided on the ‘Motherboard’ and is connected across the secure IC device. If the integrity of the heat-staked housing and grounding pins 53 are compromised, this together with the triggers the interior of the housing exposed to light, the photo sensor initiates the secure IC device to clear the cryptographic keys stored in RAM, thereby inhibiting an intruder from acquiring any cryptographic information whatsoever.

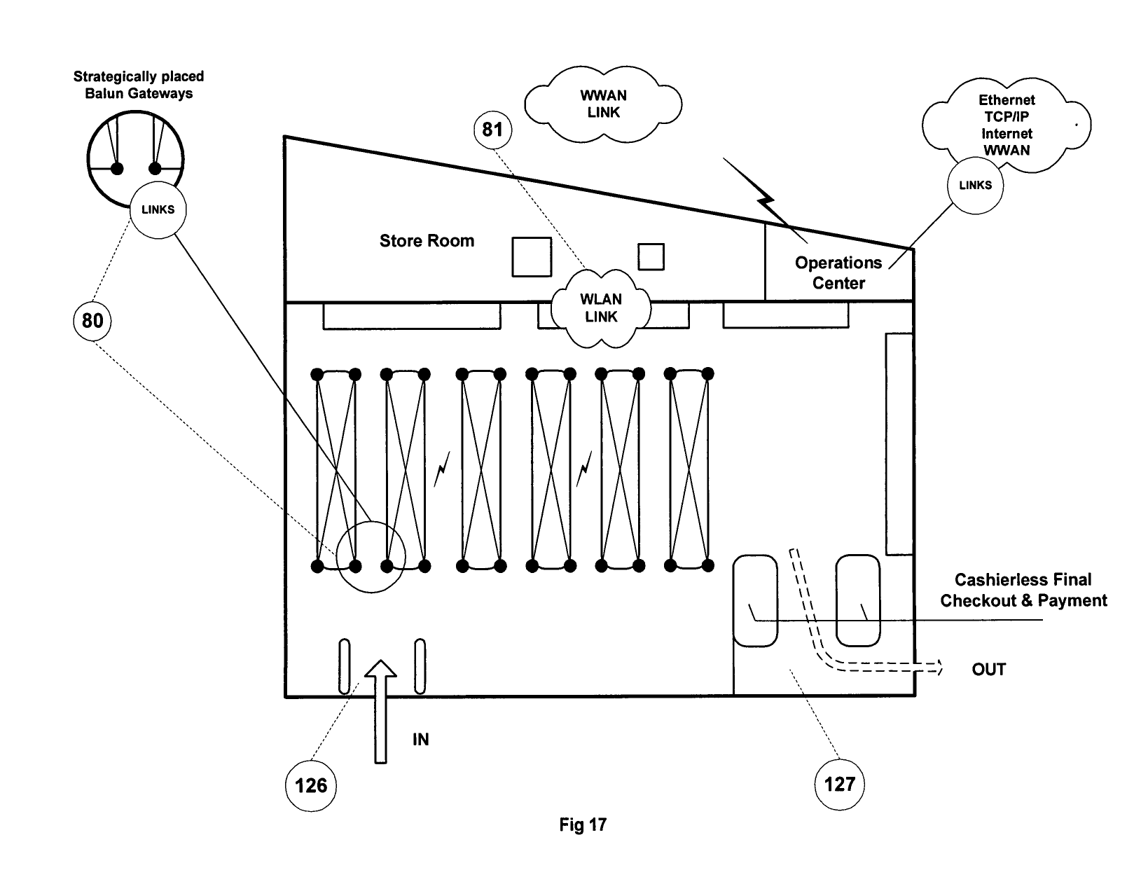

Referring to FIG. 17 the plurality of active Balun pairs situated throughout the store placed at the ends and midway points down and between the various aisles or zoned areas 80, this WLAN interconnectivity cloud 81, collects the active Balun communication in/out egress data 126 and 127 respectively.

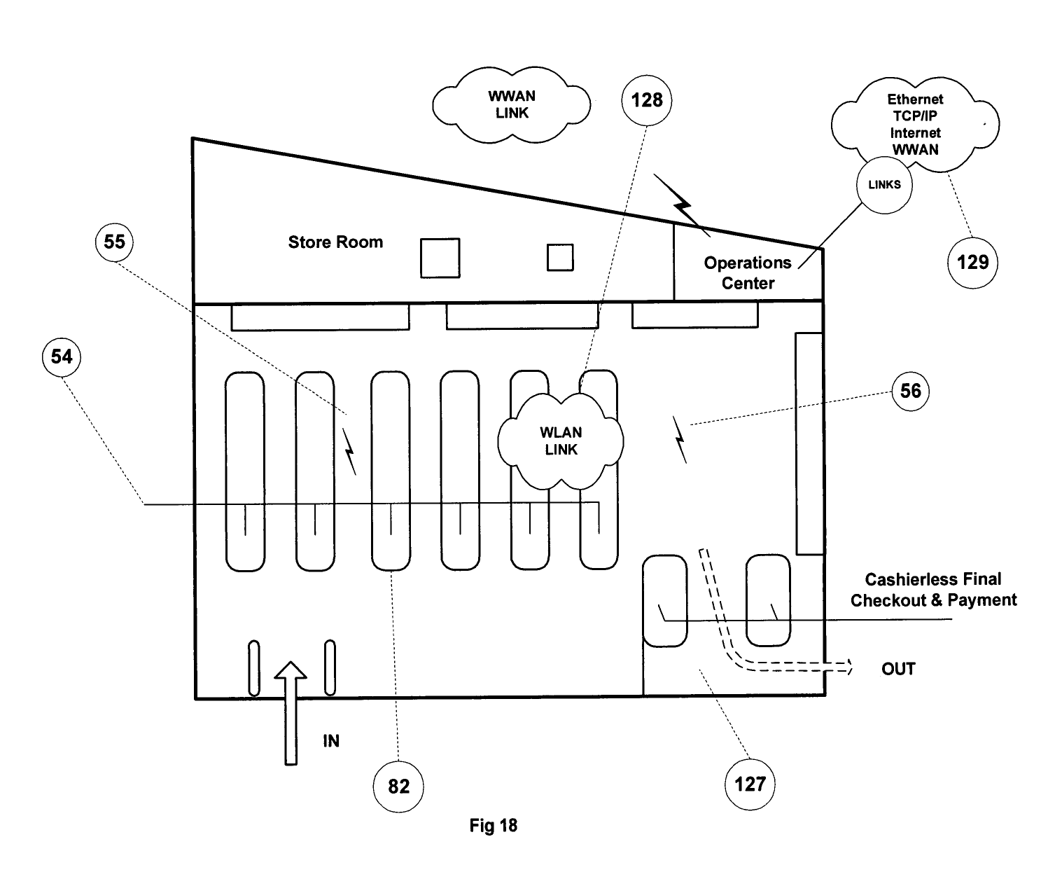

Within FIG. 18 being an entirely clustered enclave assemblage of a multitude of shopping trolleys 55 and 56, dispersed in the region of the active RFID Balun loops and WLAN antenna cluster 54 with 128 WLAN cloud overall integrated linked-networking layered combinations of communications protocols between trolley, Balun pairs WLAN and Operation Control; using ‘Virtual Gateway NOC and DirectGate for TCP/IP, Internet Cell-phone or Ethernet WWAN payments 129. This system also provides for availability to impart special and promotional downloads of merchandise and it's location. This includes information and special pricing sequentially, aisle by aisle is transmission linked to the shopping trolleys. The system also allows a shopper to enter their prerequisite shopping list into the trolley memory via a cell-phone. The shopping trolley using the store-integrated linked-network, also in turn arranges the shopping list into a typical aisle 82 prearranged catalogue that is established by Operations Center from the store comparison database information. Also, memory jogs can be flashed to provide to the trolley a memory jog reminder as a shopper proceeds through the various aisles.

Referring also to the cantilever beam 176, FIGS. 5a, 8a and 8c is configured to limit lateral movement of the bins with respect to the supporting main strut. A pre-stressed load cell is connected to the ‘Daughterboard’ to detect and provide precise weight and defined product information to the main CPU. Extending upwardly from and behind the main strut is provision for a child seat support stanchion FIG. 2a, 57. Child support frame [not shown] includes upright front posts and rearward inclined back posts with footrest and retaining waist strap. FIG. 2a an ergonomic finger curved hand-grip 58, attach to the handle proper further secured to the main strut clasp 59 providing ease of maneuvering, with provision is made for a hand wheel brake [not shown] if later required.

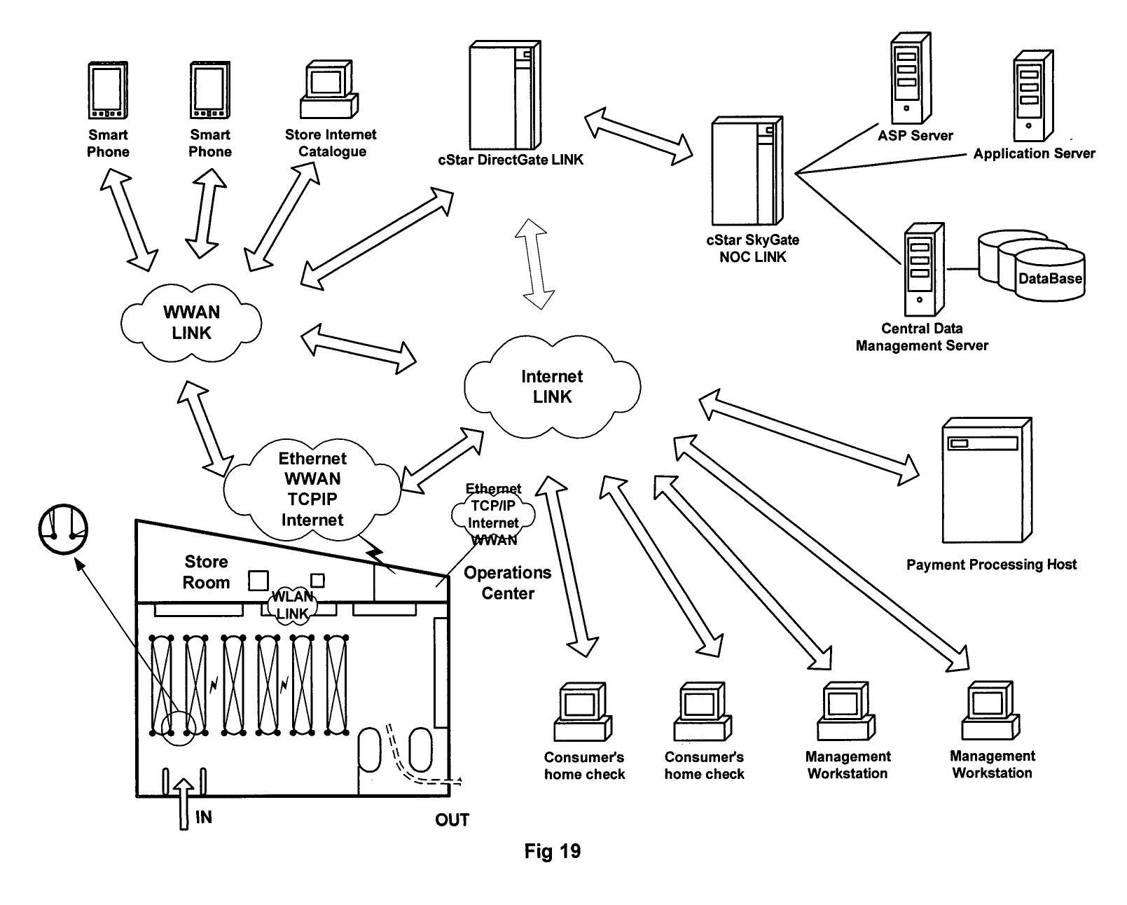

Relating to both FIG. 18 and FIG. 19, the client shopper and trolley arrive at the checkout zone illustrated as 127, the Operations Center functions as a processing Virtual Gateway. That through the layered integrated link network corroborates weight, product information volume and validates accrued pricing approval then authenticates payment through a TCP/IP means—via WWAN, Cellular, Internet or Ethernet, before printing a receipt at the checkout zone. This processing is expeditious and swift approval takes place at walking speed presupposing all checks are exact and accepted by Operations Center. A prompt express automatic disbursement TCP/IP system permits accelerated cashierless client shopper to choose their means of payment settlement; and paper prints at the exit point described, a receipt for the shopper's designated trolley acknowledge the total verification and acceptance by signature and/or provides an electronic receipt to the trolley's CPU of acceptance of the entire financial transaction.

Referring again to FIGS. 18, 19, the shopping process in a retail store and the enterprise associated with the merchandise supply pipeline, distribution and actual store allocation, Operations Center Management therein for unattended sell-through when items are purchased, the shopper then scans and places the item within the appropriate bin, however, if the comparison fails to correlate, the shopper and trolley are identified and flagged. If the shopper changes their mind and wishes to return a scanned item back onto a shelf the shopper removes the item from the bin. When this is occurs, the pre-stressed load cell FIG. 8a, detects the decrease in the weight 39 of the bin and detects its removal as it passes back out through bin brim and reports the correction information back to the Operations Center.

Once the corrective information has been received and recorded the shelf inventory is also corrected. If an altered or changed tag is introduced into the bin and the disparity variation detected by the pre-stressed load cell, the shopping trolley via the passive RFID, active RFID to Balun/Sensor array transmits an alarm signal back through the integrated link network to Operations Center which in turn sounds the flagged trolley audio alarm. A further reference arises at the checkout zone wherein all tallies do not correlate and a financial verification cannot be processed is flagging and alarm alerting Operations Center and store security.

As referred to in FIG. 16, it will be appreciated, a cashierless shopping store having an unattended point of payment zone, without the need for a cashier to handle, touch, scramble or muddle the bagging of the purchased merchandize. Allowing a shopper to purchase items, self readily group and pack, carefully arrange in the color-coded bins on the go; thus avoiding items from being damaged or leak and also preventing unwrapping and crushing. This also keeps the assortment of purchased merchandize orderly, tidy, sanitary and unsoiled.

Although a preferred embodiment of this present invention is the upgrade described, those of skill in the art will appreciate that variations and modification may be made thereto without departing from the spirit and scope thereof as defined by U.S. Pat. No. 6,725,206 B1, Apr. 20, 2004, Coveley M. ‘Cashierless Shopping Store And Components For Use Therein’.

### DETAILED DESCRIPTION OF THE PREFERRED EMBODIMENT

The application now of Passive RFID, Active RFID and other approaching cost effective sensory means, such as ultrasonic, harmonic and magnetostructive-acoustic types provide certain simplicity and cost improvements in comparison to the earlier ‘Cashierless Shopping’, U.S. Pat. No. 6,725,206 B1, Apr. 20, 2004, Coveley M. *‘Cashierless Shopping Store And Components For Use Therein’. The previous method, which required constant tally comparisons between what went into the cart and what stayed in the cart.

Referring to the independent trolley bin throat Balun loops, per bin, which convert product data with precise accuracy, as this merchandise is stacked in the various groupings within each of the bins, with each item weighed/product identified and catalogued into the trolley and Operations Center classifications. The trolley bins are enabled to now initiate any and all ‘polling’ capture into the process; the bins 60 being fitted with supplementary antennas arrangement FIG. 12, with the added induction attribute that stimulates each continuous main bin Balun loop 62. See U.S. Pat. No. 7,559,482 B2, Jul. 14, 2009, Coveley M. ‘Supplementary Antenna for RFID And Product Containing Unit Incorporating Same’; this unique technique is operative within the concertina form for partial or fully extended bins 61 and 84.

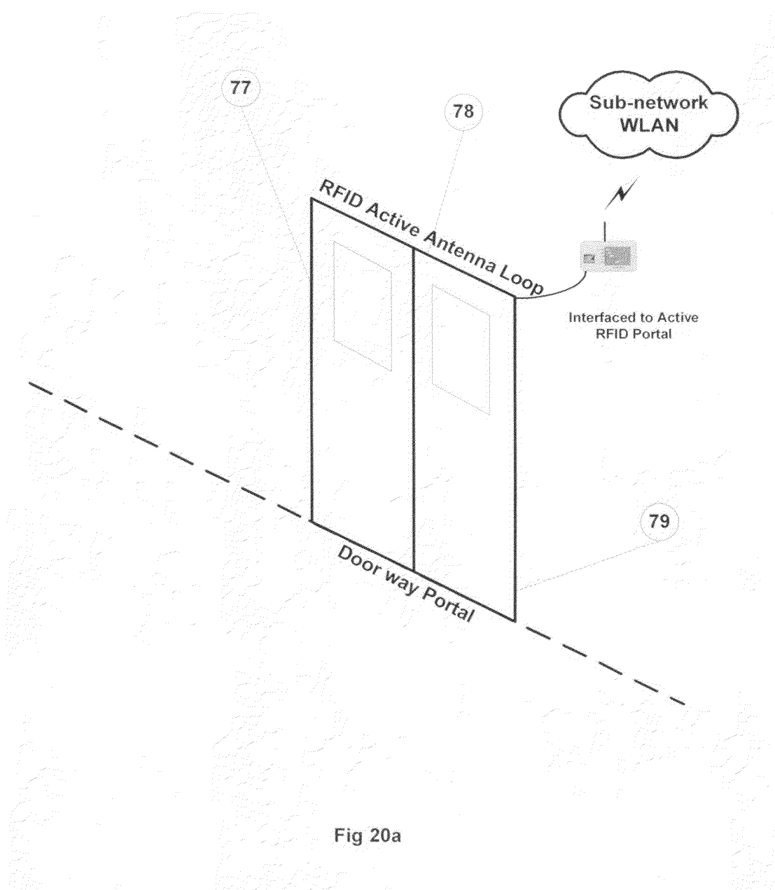

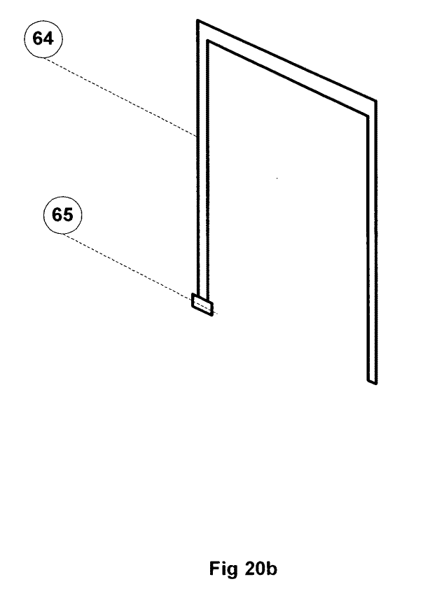

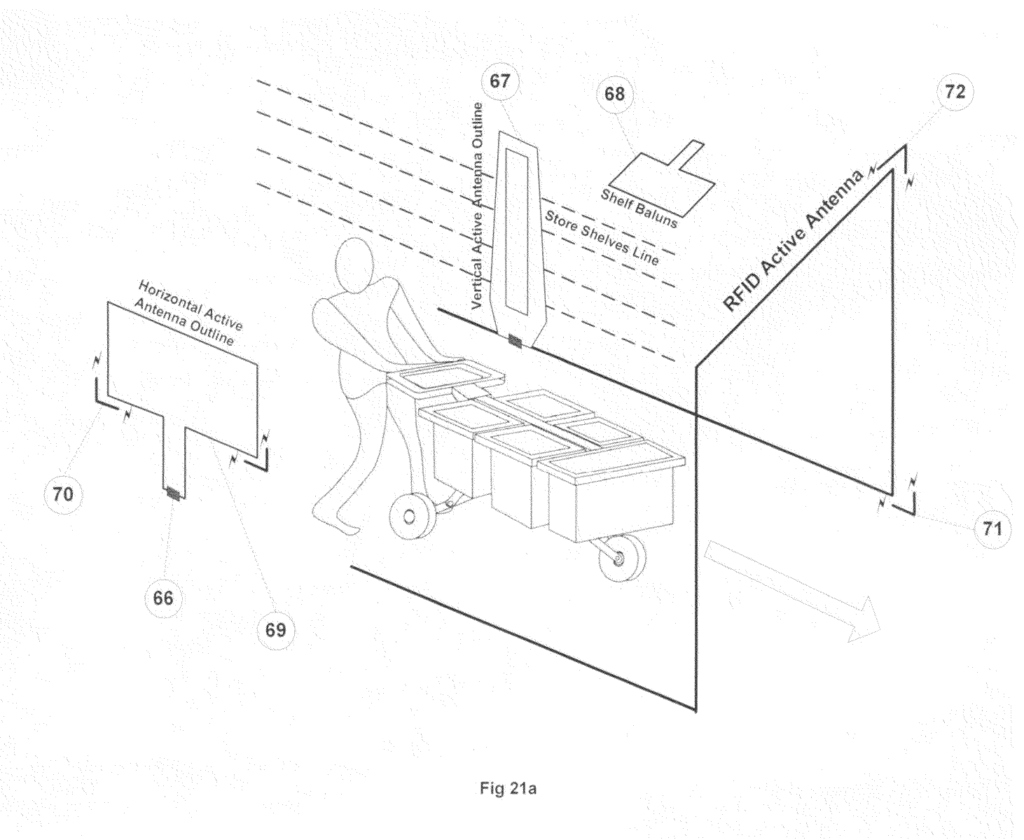

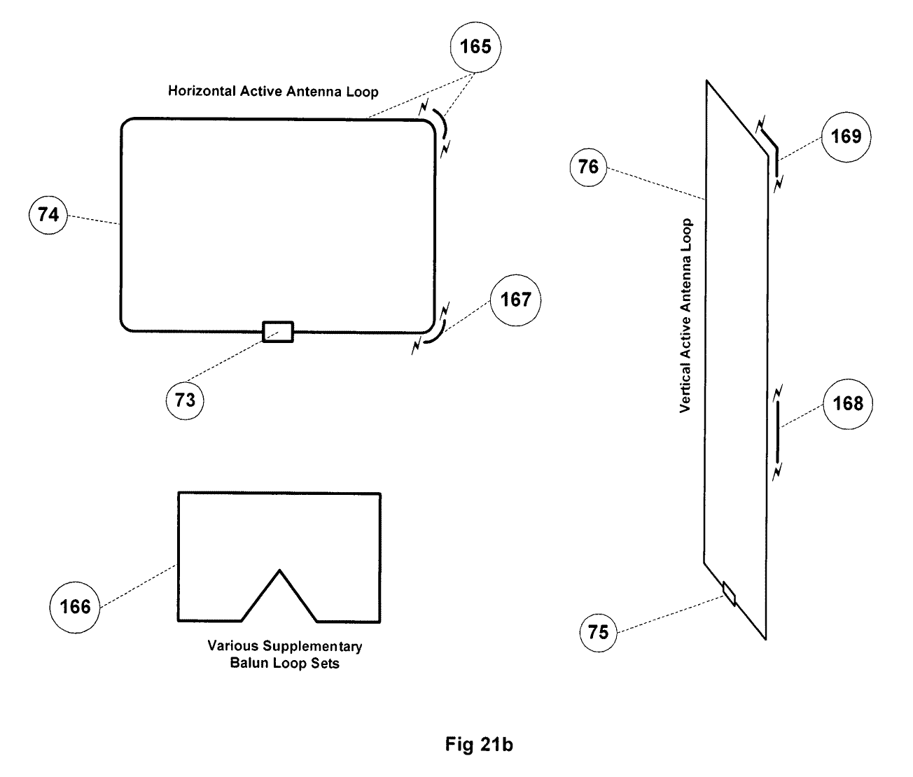

Refer to FIGS. 20b, a representative form and length of a Balun loop, up, across and down the aisle configuration 64, 65, and FIG. 21b a typical vertical aisle configuration 75, with impedance matching 76, also a typical shelf loop 74, with impedance matching 73; additionally, supplementary secondary staggered loops are shown that will allow detection of people walking in close proximity but separated by client shopper's codes 165, 167, 168, and 169; moreover a supplementary Balun loop is provided 166. Within FIG. 21a a client shopper passes during shopping a plurity arrangement of active antennas, both vertical and horizontal 66 with impedance matching and 67, 68, 69, 70, 71, 72, also with impedance matching actively collecting data peculiar to each of the trolley's contents. Non-payment default is applied in the event merchandise is removed back to the shelf or locker to adjust the inventory front-end and back-end records accordingly.

Communication compression provides a second level of security and accelerates all of the inter-processing by the process in U.S. Pat. No. 6,563,813 B1, May. 13, 2003, Coveley M. *‘Wireless Transport Protocol’. The same applies to merchandise moving between the storeroom to the store and visa versa portal-crossing shown in FIG. 20a depicting doorway active antenna Balun with integrated WLAN integrated linked network connection 77, 78, and 79 interfaced to active RFID portal with the antenna mounted insitu to door frame.

At completion of the entire shopping procedure, merchandise product match-up provides shopping ease when the trolley is wheeled though' “an exit Gateway ‘active’ Balun” configuration FIG. 21a, a final confirming ‘poll’ at Balun loops 66, 67, permit with Operations Center automatic authorization the payment process. At this point client shoppers can choose their own payment method. The Multiplexer also having WWAN, Internet and Ethernet connectivity capability process the TCP/IP transaction. U.S. Pat. No. 6,873,620 B1, Mar. 29, 2005, Coveley M. *‘Communications Server Including Virtual Gateway To Perform Protocol Conversion And Communication System Incorporating The Same’. Referring also to the Multiplexer linked Network Operations Center [NOC] integrated linked network, which handles four distinct routines [a] manages the database for [a] racks, [b] shelves, [c] chests [d] open counters; resultantly recognizes space to sales, inventory variations, merchandise monitoring to and from the storeroom, with inventory sales to client shoppers trolley 80, 81, and, including makeup changes monitored in the entire enclave through the integrated linked network depicted in FIGS. 17, and 18.

Within a pre-arranged program the client shopper may enter into a loyalty or allegiance store program obtaining either a 4 or 5-colorcoded collapsible bin arrangements and fold-up trolley suite from a particular store in the program. In yet another detail of FIG. 11a, summarizes this bin assemblage detailed in cross-section views of the bin rims proper 229 and 230; demonstrates the fully extended, partially extended and closed bin situations. Further illustrates in detail the cross-section hanging trunnion that the bin clevis toggles and suspends from 83; also shown orthographically are the self-supporting bin assemblies, as fully collapsed 228, partially collapsed 231 and fully extended 232.

Referring back to Store, Storeroom and Operations Center and the integrated linked network management of systems, which comprises e-Shop Administration and Supervision Management components which wirelessly integrate and provide the remote monitoring and match up protocols; using accurate statistical information of merchandise received firstly at storeroom front-end, handling and racking within the store, for breakdown transfer within the storeroom back-end then transitory to the store to be bought through the store by client shoppers. Thus this overall integrated method and technique includes automate supply chain order and receiving management, including space to sales reorder with support activity-based accounting.

The software control monitors and records status of product sales observes and traces sales and transactions by the client shoppers. The system provides a complete client sales transaction history set up and authorizes payment transaction through the client's chosen processor; and establishes important shopping trends.

The ‘State Diagram’ FIG. 13 shows the end-to-end continuous accumulating shopping activities within the totally enclosed trolley electronic system fastidious principles within ‘Motherboard’ and ‘Daughterboard’ functions, progressively quantifying, recording shopping inventory accruals and function evaluation during shopping progression.

A global view and summation of dispensation linked layered RFID, WLAN in store Intranets [utilizing cStar SkyGate and DirectGate NOC and Virtual Gateway Server] FIG. 19 demonstrating global TCP/IP interconnectivity linked layers with all the processing facets for Ethernet, WWAN, Internet, Cell-Phone Carriers.

The system software aids the client shopper as the touch screen roll-over display is transmitted, routine specials with shoppers advertising information and electronic coupons can be correlated to and incorporated in the shopping list, relating to store specials and promotional sales.

Store shelf space to sales and inventory draw down are detected by shelf Balun sets that divulge related logical stocking adjustments necessities to Operations Center. This consecutive information overall-scale removal establishes a trending chronicle coupled with the transaction history, of customer related information and tendencies. Also permits Operations Center observation of client shopper's comparison transaction history; Assisting specials cost control spending evenness; while being cooperative towards all conveniences to client shoppers.

### DETAILED DESCRIPTION OF THE SPECIFICATION

A state diagram of the typical cataloguing shopping process is delineate in FIG. 13 as a state diagram in article ‘a’ the Program ‘registered client’ consumer removes the folded trolley from their transport vehicle, together with the collapsible fine web polyester/nylon color-coded bins; then opens the folded trolley and installs the appropriate number of bins four or five trolley of choice for transit to the store. In article ‘b’ the client consumer's trolley upon store entry is signaled to ‘turn on’ automatically and identified through the egress Gateway Tx/Rx ‘active RFID loop element’, at the entrance Gateway. The store Control Center having recognized the client shopper, requests PIN confirmation on the numerical portion of the touch screen to allow initiate the client's shopping program. The technique is for ‘product merchandise’ to be passively scanned within the trolley. At this phase article ‘c’ the fulcrum beam load-cell with main CPU on the interconnected Motherboard and Daughterboard is calibration verified to zero, recognizing total assembled bins tare-weight, integrally to the CPU and to the store Operations Center database, communicating this information through the integrated layered wireless linked network. Exemplary in article the store Operations Center database updates the trolley main CPU with the most recent sequenced and advanced store shopping information, including in-store adjustments, client shoppers current points awards and takes into account digital coupons status; conveying specially highlighted special items.

In article ‘e’ it is to be noted that ‘the whole’ of the shopping ongoing process computation, by enumeration and verification is performed insitu within the trolley, by the low voltage Motherboard CPU and interconnected Daughterboard slave with embedded software; this information is also conveyed upon ‘poling’ to the Operations Center database

Also in FIG. 13-f as the trolley enters each aisle or zone, it is ‘poled’ by the Balun Gateway re-emphasizing that aisle sector flagged specials from Operations Center database. As an element of the Cashierless intelligent system, each Balun pair are ‘poled’ at regular intervals by Operations Center to ensure they are ‘on standby’ and functional. As a trolley passes each Balun pair, the active RFID Balun congregates the trolley's current shopping inventory status, which is then forwarded on via the store WLAN using a WTP securely to the Operations Center NOC. The shopping comparison as it alters, during the purchase process is held both in the trolley and concurrently in the store Operations Center database.

Again in FIG. 13-g the basic process for the client shopper's procedure is for barcode, passive RFID or other labeling such as ultrasonic, harmonic, magnetostructive-acoustic types that are in use. By scanning these product items either by the existing barcode reader laser or the bin brim coercive sensor detection field, that exists in the throat of each bin.

Further in FIG. 13-h the pneumatic nitrogen pre-strained Load Cell verifies exact specific information of item's weight, signal communicating this through the ‘Fulcrum Beam’ to the Daughterboard, which is further processed as product type and value conceived and deposited to ‘flash’ stored memory by route of the Daughterboard, then accumulated, verification substantiate in the Motherboard's main CPU for furthering when ‘poled’ to Operations Center.

In FIG. 13-i the shopper advances from aisle to aisle transiting through the various active RFID Balun Gateways, wherein the trolley is repetitively ‘poled’ and communicates by active RFID the shopping accrual onto store WLAN [NOC] link Network Operational Control at the Operations Center, where it is replicate compared and automatically recorded in the database.

Again in FIG. 13-j with this ‘Intelligent System’ duplication overlay method, having the trolley performing integrally the entire resources matching and validation, at the same time updating the inventory shelf refill instruction and prompt inducing the retail pipeline-reordering system by the WWAN ‘ThruGate’ at Operations Center of all accruals made by the automatic ‘poling’ means. The integrated link network recurrently authenticates all the various shoppers, in progression, for trolley correctness but will immediately flag any process factual inaccuracy or deliberate blunder.

Further in FIG. 13-k another part of the SkyGate Inventory Management Application, running at the Server NOC, supplementary purpose and task is to stack record shopping approved accruals of taken up produce and then used for shelf-refill from the store warehouse to avoid ‘space to sales’ occurring on any empty shelf.

Again in FIG. 13-l as the trolley approaches the checkout zone active RFID mechanisms tally and are spontaneously re-scrutinized, substantiated; allowing the consumer shopper to choose the method of reimbursement payment to the store. Completed through TCP/IP WWAN [or other means] on-the-fly, allows shoppers exodus with a receipt printed and issued for that trolley code upon departure.

Additionally, in FIG. 13-m the consumer is now able to leave with personal fold-up trolley and progress to their transport.

Recounting the actual product shopping interchange being achieved 236, from the shelf already presided over by the shelf Balun, over towards the trolley bin as referred to in FIG. 13-n, wherein the client shopper has removed the product items from the store shelves, the shelves are fitted with ‘active Balun RFID Loop’ antennas 68. In this respect the Balun Loops report this subtraction through the WLAN Link separately to the Operations Center where it is systematically catalogued.

Furthermore, in a continuation of this typical example of shopping from shelf to trolley bin, as a replicating interchange 237, shown in FIG. 13-o the client shopper having removed this items from the shelf, in this normal way of trolley bin loading, passes the product item through the throat of the bin, where it is recognized and read, alternatively in a similar way passed by the barcode reader. Recognition of label data and weight comparison evaluation tally, being the internal processing function of the trolley proper. This calculated and evaluated data is now stored within the trolley CPU where it resides until any store active Balun pair, pole the trolley contents. This constant inventory summary is carried forward, the cross-referencing forming, in part, reckoning to the final checkout evaluation; the advancing accrual is later used in the reordering process for pipeline progression requirements.

1. A cashierless shopping store comprising at least one shopping trolley mounted with a plurity of attached color-coded bins into which passive tagged merchandize items are placed and scanned by a range of various and alternative reading sensor encapsulated into the bin rim, comprising at least a barcode reading laser system connective set, which includes the means to detect weight of items so placed therein and resources to evaluate and rate value the scanned information jointly with detected weight internally through the trolley communication link with the CPU.

2. A cashierless shopping store as defined in claim 1 comprising at least one shopping trolley mounted with a plurity of attached color-coded bins into which passive tagged merchandize items are placed and scanned by a range of various and alternative reading sensor encapsulated into the bin rim, comprising at least an active RFID reading and transmitting system communication set, which includes the resources to detect weight of items so placed therein and means to evaluate and rate value the scanned information with detected weight internally over the trolley communication link to the CPU.

3. A cashierless shopping store as defined in claim 2 comprising at least one shopping trolley mounted with a plurity of attached color-coded bins into which passive tagged merchandize items are placed and scanned by a range of various and alternative reading sensors encapsulated into the bin rim, comprising at least an ultrasonic reading and transmitting system connective set, which includes the means to detect weight of items so placed therein and resources to evaluate and rate value the scanned information together with detected weight internally over the trolley communication link to the CPU.

4. A cashierless shopping store as defined in claim 3 comprising at least one shopping trolley mounted with a plurity of attached color-coded bins into which passive tagged merchandize items are placed and scanned by a range of various and alternative reading sensors encapsulated into the bin rim, comprising, at least a magno-acoustic/harmonic reading and transmitting system communication set, which includes the means to detect weight of items so placed therein and resources to evaluate and rate value the scanned information together with detected weight internally over the trolley communication link to the CPU.

5. A cashierless shopping store as defined in claim 4 comprising at least one fold-up and break-down shopping trolley mounted with a plurity of attached color-coded bins comprising the four or five configuration into which passive tagged merchandize items are individually placed.

6. A cashierless shopping store as defined in claim 5 said at least one shopping trolley incorporates mounted on the trolley center vertical strut one cantilever beam assembly, said beam assembly contains a totally enclosed integral set of interconnected electronic processing components connected insitu within to the said loadcell weighing means

7. A cashierless shopping store as defined in claim 6 said at least one shopping trolley incorporates coupled CPU components mounted within the trolley cantilever beam assembly, said beam assembly containing two totally integrated controllers including said CPU components, which are able to recognize, register and act upon received accurate said sensor data, to evaluation calculate, authorize and record store said data within said trolley main Motherboard CPU.

8. A cashierless shopping store as defined in claim 7 said at least one shopping trolley incorporates an RFID antenna mounted within said supporting cantilever beam, being a passive/active RFID Balun duplex pair connected to the said trolley main Motherboard CPU; such that when ‘poled’ by any store externally mounted passive/active Balun duplex pair passing between or nearby them, conveys and discloses existing stored current shopping accumulated data from said identified trolley CPU.

9. A cashierless shopping store as defined in claim 8 contains at least one passive/active RFID Balun pair within the store environment is connected to a WLAN intranet linked to the store Operations Center NOC where identified comparison information collected and evaluation matched to the store database is recorded for concluding use at the said store automatic checkout zone, and further use for inventory cataloguing and pipeline of supply reordering necessities.

10. A cashierless shopping store as defined in claim 9 further comprising an Operations Center, which is in communication with said at least one shopping trolley over said store active Balun RFID district pairs and active RFID Balun shelf pairs being interconnected to the said duplex wireless communication linked network; said Operations Center upon receiving accurate data of shelf space to sales emulated data is corresponding accredited to store registering data base.

11. A cashierless shopping store as defined in claim 10 being a method of shopping for merchandise items comprising the steps of scanning or reading item classification, value and weight data from selected items being purchased, placing said selected items into the shopping trolley bins; computing and accepting the established quantum prior to CPU memory supplement.

12. A cashierless shopping store as defined in claim 11 providing for a method of further encompassing necessary steps to error flag if said quantum comparison does not correlate within the trolley CPU evaluation, advising the shopper first for convenience of the error, which shopper must correct before an established timeout, set by the Operations Center and their participation.

13. A cashierless shopping store as defined in claim 12 further comprising the accrual and compilation of the main CPU memory capability within the trolley, wherein generated evaluated data is accepted and memory held awaiting the various ‘poling’ requests for the compilation accrued as approved merchandise shopping.

14. A cashierless shopping store as defined in claim 13 utilizing a fold-up device comprising: a three wheeled lightweight trolley; onto which is installed a set of four or five concertina RFID rimmed bins removable to and from a trunnion support on said cantilever beam; the bins are used for orderly placement of items to be purchased and placed therein, said color-coded bins form their own partition making a plurality of individual separated compartments, receiving and organizing assorted items during shopping.

15. A cashierless shopping store as defined in claim 14 comprising: a plurality of such shopping trolleys individually identified by Operations Center, into which selected items being purchased are placed by shoppers into their personal said shopping trolleys.

16. A cashierless shopping store according to claim 15 wherein each shopping trolley includes a plurality of mounted bin rim scanners, individually or collectively including an active RFID Balun, an ultrasonic, harmonic, magnetostructive-acoustic set of readers that are able to read said merchandise items price, product type or code and item specific weight when placed within the trolley bins and data passed to the CPU memory chip.

17. A cashierless shopping store according to claim 16 wherein said merchandise scanning may also be performed by a bar code scanner if that system is still being utilized before placement into the said trolley bins.

18. A cashierless shopping store according to claim 17 wherein each shopping trolley main CPU includes a TCP/IP payment processing means that is generated from the trolley and a financial transaction request based on the check-sum of accurately read and recorded item types retained in the trolley bins and CPU memory, weight and price quantum is comparison matched by Operations Center, acknowledged and accepted allowing completing of a financial transaction request based on meticulous calculated evaluation within trolley CPU.

19. A cashierless shopping store according to claim 18 wherein said at least the exit zone includes an exit gateway and printer when said identified trolley financial transaction request is approved, wherein either a ‘paper receipt’ or electronic trolley CPU receipt is obtained.

20. A cashierless shopping store according to claim 19 wherein an audio alarm is sounded at the checkout zone entrance and the trolley proper if the recorded trolley data, as parallel compared with Operations Center quantum ‘check-sum’ does not match specifically.

21. A cashierless shopping store according to claim 20 wherein each shopping trolley further includes a retractable internal display wherein exhibiting specials, exclusive pricing information, advertising and menu suggestion, transmitted over said integrated WLAN communications link network can be displayed.

22. A cashierless shopping store trolley according to claim 21 further comprising a cantilever beam battery power source integral to the trolley proper with low battery warning, using four U2 NiCad rechargeable batteries.

23. A cashierless shopping store according to claim 22 wherein the shopping trolley cantilever beam includes trunnion mounts for mounting of said empty bins, allowing calibration to zero ‘0’ by the control center after consideration of prior record quantified tare weight.

24. A cashierless shopping store according to claim 23 wherein a cell phone communicative dock on the trolley cantilever beam, is connectively coupled both to the trolley, and to the store control center via the trolley and to the integrated WWAN system availability.

25. A cashierless shopping store according to claim 24 wherein a lightweight fold-up, and stow away robust three wheel plastic trolley with said integrated processing communicative electronics, housed in the cantilever beam, is connected to the store integrated link network; upon unfolding and arrival into the store entrance active Balun pair, for recognition, and up to date latest shopping statistics by the store Control Center.

26. A cashierless shopping store according to claim 25 wherein unhygienic and soiled metal carts are replaced by a client shopper owned, fold-up robust lightweight composite plastic three-wheeled trolley provided privately or under terms of the store to a client shopper loyalty provisions program.

27. A cashierless shopping store according to claim 26 wherein, following environmental laws, the uses of non-biodegradable plastic bags or carry-out disposable ‘kraft-paper’ bags are completely replaced by woven plastic concertina color-coded bins that are client shopper owned, long-lasting, durable, reusable, provided under store loyalty program provisions.

28. A cashierless shopping store according to claim 27 as said by to the present combined invention claims provide an intrinsic, comprehensive ‘state of affairs’ shopping, establishing overall security shopping safeguards while affording provision for convenience being shopper friendly.

29. A cashierless shopping store according to claim 28 wherein a further aspect makes information congregated and transmitted from both the store vertical active Balun pairs, or continual plurality of shelf horizontal active Balun pairs with supplementary antennas also collect and further collaborate shoppers take-up trends to the store database, further correlation being beneficial to re-order and pipeline of supply requirements.

30. A cashierless shopping store according to claim 29 wherein advantages from monitoring inclination, location and coordinates of appropriate discount merchandise produce trolley enunciated, client shopper can be advised by Operations Center as to their respective locations by aisle and shelf coordinates.

31. A cashierless shopping store according to claim 30 wherein the present invention also makes available the stored and forwarded data from the summation of the walk-thru’ active Balun pairs entering the checkout zone, real-time recorded by Operations Center wherein an un-flagged audited trolley is satisfactorily able to commence TCP/IP transaction processes, that are prompt and achieved at walk-through speed with choice of a printed receipt of the transaction available in paper form or electronic form at the exiting gateway.

32. A cashierless shopping store according to claim 31 wherein a trolley fagged error must be client shopper corrected immediately in order to continue shopping, remaining uncorrected, will require Control Center participation well prior to the exit zone, followed by further reoccurring fagged errors/faults will automatically engage store security survey and involvement.

33. A cashierless shopping store according to claim 32 permits the shopper to leave the store with their trolley and bins in an organized manner, then able to stow bins and trolley into their transportation; arriving home with well organized merchandise making for easy organized home accommodation.

34. A cashierless shopping store according to claim 33 provides an active RFID Balun paired doorway portal surveillance curtain from inwards merchandise at the backend loading dock, monitored and inward inventory catalogued from delivery truck to storeroom racking monitored by Control Center NOC.

35. A cashierless shopping store according to claim 34 provides an active RFID storeroom shelf surveillance of carboy or bulk pallet breakdown and for onward distribution through store proper egress portals containing active RFID Balun pairs from storeroom, inventory catalogued by Control Center NOC.

36. A cashierless shopping store according to claim 35 wherein overall inventory stocktaking can be made at short repeat intervals in order to administer and manipulate movement of said merchandise throughout districts of the storeroom, to store, to unattended point of sale cashierless zone for accurate purchase of merchandize.
